(19) United States
(12) Patent Application Publication
(10) Pub. No.: US 2025/0386242 A1
(43) Pub. Date: Dec. 18, 2025

(54) MODEL MANAGEMENT FOR CONTROL CHANNEL ENCODING OR DECODING

(71) Applicant: QUALCOMM Incorporated, San Diego, CA (US)

(72) Inventors: Akash Sandeep DOSHI, San Diego, CA (US); Wei YANG, San Diego, CA (US); June NAMGOONG, San Diego, CA (US); Taesang YOO, San Diego, CA (US); Pinar SEN, San Diego, CA (US); Kirill IVANOV, La Jolla, CA (US); Jing JIANG, San Diego, CA (US)

(21) Appl. No.: 18/742,731

(22) Filed: Jun. 13, 2024

(51) Int. Cl. H04W 28/06; H04L 41/14; H04L 41/16; H04W 72/20

(52) U.S. Cl. CPC H04W 28/06; H04L 41/145; H04L 41/16; H04W 72/20

(57) ABSTRACT

In some implementations, a wireless node may obtain an indication that a model, associated with at least one of encoding or decoding, is to be used in association with a control channel. The wireless node may output, after obtaining the indication, one or more model parameters associated with a data distribution of the control channel. The wireless node may encode data by using the one or more model parameters. The wireless node may output the data for transmission via the control channel.

### FIELD OF THE DISCLOSURE

Aspects of the present disclosure generally relate to wireless communication and specifically relate to techniques, apparatuses, and methods associated with model management for control channel encoding or decoding.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

In some aspects, an apparatus for wireless communication includes one or more memories comprising instructions; and one or more processors configured to execute the instructions and cause the apparatus to: obtain an indication that a model, associated with at least one of encoding or decoding, is to be used in association with a control channel; output, after obtaining the indication, one or more model parameters associated with a data distribution of the control channel; encode data by using the one or more model parameters; and output the data for transmission via the control channel.

In some aspects, an apparatus for wireless communication includes one or more memories comprising instructions; and one or more processors configured to execute the instructions and cause the apparatus to: output an indication that a model, associated with at least one of encoding or decoding, is to be used in association with a control channel; obtain, after outputting the indication that the model is to be used, one or more model parameters associated with a data distribution of the control channel; obtain data associated with the control channel; and decode the data by using the one or more model parameters.

In some aspects, a method of wireless communication performed at a wireless node includes obtaining an indication that a model, associated with at least one of encoding or decoding, is to be used in association with a control channel; outputting, after obtaining the indication, one or more model parameters associated with a data distribution of the control channel; encoding data by using the one or more model parameters; and outputting the data for transmission via the control channel.

In some aspects, a method of wireless communication performed at a wireless node includes outputting an indication that a model, associated with at least one of encoding or decoding, is to be used in association with a control channel; obtaining, after outputting the indication that the model is to be used, one or more model parameters associated with a data distribution of the control channel; obtaining data associated with the control channel; and decoding the data by using the one or more model parameters.

In some aspects, a non-transitory computer-readable medium comprising: instructions that, when executed by an apparatus, cause the apparatus to: obtain an indication that a model, associated with at least one of encoding or decoding, is to be used in association with a control channel; output, after obtaining the indication, one or more model parameters associated with a data distribution of the control channel; encode data by using the one or more model parameters; and output the data for transmission via the control channel.

In some aspects, a non-transitory computer-readable medium comprising: instructions that, when executed by an apparatus, cause the apparatus to: output an indication that a model, associated with at least one of encoding or decoding, is to be used in association with a control channel; obtain, after outputting the indication that the model is to be used, one or more model parameters associated with a data distribution of the control channel; obtain data associated with the control channel; and decode the data by using the one or more model parameters.

In some aspects, an apparatus for wireless communication includes means for obtaining an indication that a model, associated with at least one of encoding or decoding, is to be used in association with a control channel; means for outputting, after obtaining the indication, one or more model parameters associated with a data distribution of the control channel; means for encoding data by using the one or more model parameters; and means for outputting the data for transmission via the control channel.

In some aspects, an apparatus for wireless communication includes means for outputting an indication that a model, associated with at least one of encoding or decoding, is to be used in association with a control channel; means for obtaining, after outputting the indication that the model is to be used, one or more model parameters associated with a data distribution of the control channel; means for obtaining data associated with the control channel; and means for decoding the data by using the one or more model parameters.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example network node in communication with an example user equipment (UE) in a wireless network, in accordance with the present disclosure.

FIG. 3 is a diagram illustrating an example disaggregated base station architecture, in accordance with the present disclosure.

FIG. 4 is a diagram illustrating an example of physical channels and reference signals in a wireless network, in accordance with the present disclosure.

FIG. 5 is a diagram illustrating an example of link adaptation, in accordance with the present disclosure.

FIG. 6 is a diagram of an example associated with model management for control channel encoding or decoding, in accordance with the present disclosure.

FIG. 7 is a diagram of an example associated with model management for control channel encoding or decoding, in accordance with the present disclosure.

FIG. 8 is a diagram of an example associated with model management for control channel encoding or decoding, in accordance with the present disclosure.

FIG. 9 is a diagram illustrating an example process performed, for example, at a UE or an apparatus of a UE, in accordance with the present disclosure.

FIG. 10 is a diagram illustrating an example process performed, for example, at a network node or an apparatus of a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some examples, a wireless node (e.g., a network node or a user equipment (UE)) may transmit a type of communication in which probabilities of certain types of information being included in a given communication are non-uniform. For example, the type of communication may include feedback information. The feedback information may include hybrid automatic repeat request (HARQ) feedback and/or a feedback codebook. In the context of feedback information (e.g., HARQ feedback), “codebook” refers to a set of one or more (e.g., a matrix of one or more) feedback indications (e.g., acknowledgement (ACK) or negative ACK (NACK) indications) that can be transmitted via a single transmission (e.g., a single uplink transmission). In some cases, the network entity (e.g., a UE) may support HARQ feedback codebook transmissions. A HARQ feedback codebook transmission may include a feedback message that the network entity is to transmit to another network entity to provide feedback regarding, for example, downlink data transmission (for example, transmissions associated with a downlink channel). As used herein, a codebook may be a sequence of bits, which may be constructed using ACK/NACK feedback associated with multiple communications (e.g., multiple downlink communications) that are received by a network entity during a feedback window. A codebook may include one or more codewords. A codeword may include a message or communication. For example, a codeword may include one or more ACK/NACK feedback indications (e.g., a sequence of one or more HARQ ACK bit values and/or HARQ NACK bit values).

As described elsewhere herein, the wireless node may communicate using one or more communication parameters that are configured to achieve a target error rate for a given channel, such as a downlink channel. The wireless node may transmit a codebook indicating feedback (e.g., HARQ ACK/NACK feedback) for the given channel. Because the communication parameter(s) are configured to achieve the target error rate (e.g., target block error rate (BLER)) for the given channel, the feedback information for the given channel will be biased and/or non-uniform. For example, if the target BLER for the given channel is 10%, then the probability that feedback is ACK feedback is 90% for a given communication (e.g., a given transport block) transmitted via the given channel. In some examples, codebooks may be designed for uniform probability of messages with equal likelihood of the bit 0 and bit 1. In such examples, power is applied uniformly to all codewords in the codebook. For example, each codeword may be transmitted using the same transmit power. This results in inefficient power usage by the wireless node transmitting the codebook.

In some examples, the wireless node may utilize techniques for power shaping associated with non-uniform message transmissions to improve power savings. For example, more power may be proportionately assigned to less likely symbols (e.g., less likely codewords) and less power to more likely symbols (e.g., more likely codewords) to reduce the average transmit power and improve error performance (e.g., to reduce the average transmit power associated with meeting a given target error rate). For example, the wireless node may scale a power of a codeword based on, or otherwise associated with, a probability associated with the codeword. As an example, the wireless node may perform a power scaling procedure for the codeword c(x^{k}) based on a power shaping parameter. In some examples, the second wireless node may receive the power shaping parameter from the first wireless node. In some examples, the power shaping parameter may be associated with a non-uniform probability of respective portions of the message x^{k}. For example, the power shaping procedure may use a power shaping parameter of

$$log ( \frac{1}{p ( {x}^{k} )} ) ,$$

where p(x^{k}) is the non-uniform probability of the message x^{k}. The message x^{k} may include one or more feedback indications, such as HARQ ACK indications or HARQ NACK indications, among other examples. In other words, if a codeword c has probability π_{c}, then the transmit power allocated to that codeword may be proportional to the probability associated with the codeword (e.g., P_{c} ∝−log π_{c}, where P_{c} is a power shaping parameter).

In some examples, the probabilities of respective codewords included in the codebook (e.g., included in control channel data) may vary over time. Therefore, using a given encoder (e.g., the same encoder) to encode the control channel data (e.g., using a given codebook and given set of power shaping parameters) may result in degraded communication performance in some examples. As used herein, “encoder” refers to a codebook and a power shaping scheme (e.g., a set of power shaping parameters associated with respective codewords in the codebook). For example, the encoder may be configured or designed to improve performance of control channel transmissions for a given data distribution (e.g., a probability distribution for codewords) associated with the control channel transmissions. As the data distribution associated with the control channel may change over time, a performance of control channel transmission transmitted by the wireless node (e.g., that are encoded using the encoder) may be degraded in some cases, such as when the data distribution differs from the data distribution that was used to configure or design the encoder. Additionally, for some data distributions of the control channel and/or for some conditions (e.g., channel conditions and/or wireless node conditions), the power-shaping-based encoding described herein may result in degraded performance as compared to an encoding operation that does not use a power shaping scheme. However, wireless nodes (e.g., a UE and/or a network node) may not be synchronized as to the current data distribution (e.g., probability distribution) associated with the control channel (e.g., a first wireless node may estimate the data distribution, but a second wireless node may not obtain or determine the data distribution). Therefore, modifying the encoding and/or decoding scheme (e.g., as the data distribution changes) may result in errors (e.g., decoding errors) and/or failed communications, among other examples.

Various aspects relate generally to model management for control channel encoding or decoding. Some aspects more specifically relate to using a model (e.g., associated with encoding and/or decoding for a control channel) to tailor an encoding operations and/or a decoding operation to a data distribution associated with the control channel. The control channel may be an uplink control channel (e.g., a physical uplink control channel (PUCCH)) or another type of control channel, such as a downlink control channel or a sidelink control channel. In some aspects, the model may be a data distribution model configured to output or generate one or more model parameters that are indicative of the data distribution of the control channel. For example, a wireless node (e.g., a UE or a network node) may obtain, using the model, the one or more model parameters based on one or more historical (e.g., previously transmitted) control channel transmissions. A first wireless node may output for transmission (e.g., to a second wireless node) the one or more model parameters. The first wireless node may encode data associated with the control channel by using the one or more model parameters. For example, an encoder (e.g., a codebook and/or one or more power shaping parameters used for encoding) may be based on, or otherwise associated with, the one or more model parameters. The encoder may be associated with (e.g., based on) the one or more model parameters. For example, the encoder may include a codebook and/or one or more power shaping parameters that are determined (e.g., selected or calculated) using the one or more model parameters and/or the data distribution.

The second wireless node may decode the data by using the one or more model parameters (e.g., using a decoder and/or a codebook and/or one or more power shaping parameters used for the encoding). The decoder may be associated with (e.g., based on) the one or more model parameters. For example, the second wireless node may use the one or more model parameters to determine a prior (e.g., a prior distribution) associated with the decoder, such as a maximum a posteriori (MAP)-based decoder. Additionally, or alternatively, the second wireless node may decode the data using a codebook and/or one or more power shaping parameters that are determined or selected using the one or more model parameters and/or the data distribution (e.g., using the encoder that is associated with the one or more model parameters).

In some aspects, a wireless node (e.g., the first wireless node and/or the second wireless node) may output for transmission, and another wireless node (e.g., the second wireless node and/or the first wireless node) may obtain (e.g., receive), an indication that the model is to be used in association with the control channel (e.g., in association with updating or modifying an encoding scheme and/or decoding scheme for the control channel). For example, the indication may be included in a radio resource control (RRC) communication, a medium access control (MAC) communication (e.g., a MAC control element (MAC-CE), and/or another type of communication). The indication may indicate that a scenario-specific (e.g., data-distribution-specific) encoding scheme and/or decoding scheme is to be used for the control channel. The first wireless node may obtain the one or more model parameters based on, or otherwise associated with, the indication that the model is to be used in association with the control channel.

In some aspects, the first wireless node and/or the second wireless node may obtain the codebook and/or the one or more power shaping parameters (e.g. the encoder) via a server (e.g., a server device), another device, or a network function or service. For example, the first wireless node may output for transmission to the server (or other device) the one or more model parameters. The server may identify or select the codebook and/or the one or more power shaping parameters to be used for encoding (e.g., may identify and/or select the encoder) after obtaining the one or more model parameters. The server may transmit, and the first wireless node and/or the second wireless node may obtain, the codebook and/or the one or more power shaping parameters (e.g., the encoder) after the first wireless node outputs the one or more model parameters. The first wireless node may use the codebook and/or the one or more power shaping parameters for encoding the data. Additionally, or alternatively, the second wireless node may use codebook and/or the one or more power shaping parameters for decoding the data.

Particular aspects of the subject matter described in this disclosure can be implemented to realize one or more of the following potential advantages. In some examples, by communicating the indicating that the model is to be used in association with the control channel (e.g., by communicating an indication that a scenario-specific (e.g., data-distribution-specific) encoding scheme and/or decoding scheme is to be used for the control channel), the described techniques can be used to enable wireless nodes to be synchronized as to when and/or how a data distribution of the control channel is to be used to configure or determine the encoding scheme and/or decoding scheme. This may reduce the likelihood of errors (e.g., decoding errors) and/or failed transmissions associated with the control channel. As another example, by communicating the one or more model parameters, the wireless nodes may use an encoding scheme and/or decoding scheme for the control channel that is tailored to the current data distribution of the control channel (e.g., the current probability distribution associated with one or more codewords). This may improve the performance of communications via the control channel (e.g., improve encoding and/or decoding performance). Additionally, by using the encoding scheme and/or decoding scheme for the control channel that is tailored to the current data distribution of the control channel, the wireless nodes may improve power (e.g., transmit power) efficiency of communications associated with the control channel. In some aspects, by enabling the server to select the encoder using the model parameters, the wireless node(s) may conserve processing resources, computing resources, and/or memory resources that would have otherwise been associated with selecting an encoder (e.g., using the one or more model parameters) from multiple encoders and/or storing the multiple encoders, among other examples.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (cMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

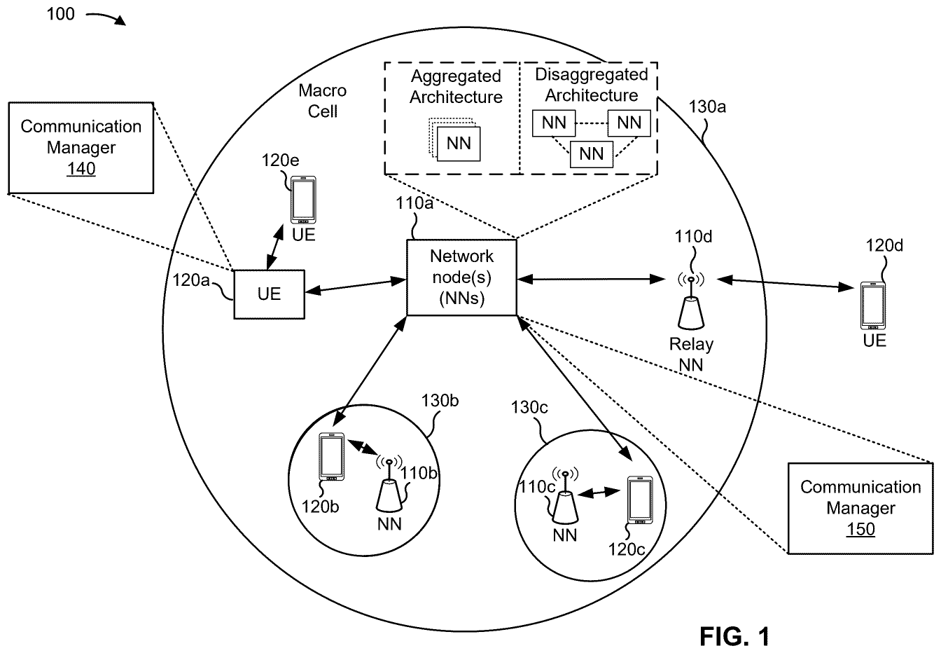

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHz), FR4 (52.6 GHZ through 114.25 GHZ), and FR5 (114.25 GHz through 300 GHz). Although a portion of FRI is greater than 6 GHZ, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FRI or FR2 into mid-band frequencies. Thus, “sub-6 GHz,” if used herein, may broadly refer to frequencies that are less than 6 GHZ, that are within FRI, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FRI, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as RRC functions, packet data convergence protocol (PDCP) functions, and/or service data adaptation protocol (SDAP) functions, among other examples. A DU may host one or more of a radio link control (RLC) layer, a MAC layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more PUCCHs, and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120c in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may obtain an indication that a model, associated with at least one of encoding or decoding, is to be used in association with a control channel; output, after obtaining the indication, one or more model parameters associated with a data distribution of the control channel; encode data by using the one or more model parameters; and output the data for transmission via the control channel. Additionally, or alternatively, the communication manager 140 may perform one or more other operations described herein.

In some aspects, the network node 110 may include a communication manager 150. As described in more detail elsewhere herein, the communication manager 150 may output an indication that a model, associated with at least one of encoding or decoding, is to be used in association with a control channel; obtain, after outputting the indication that the model is to be used, one or more model parameters associated with a data distribution of the control channel; obtain data associated with the control channel; and decode the data by using the one or more model parameters. Additionally, or alternatively, the communication manager 150 may perform one or more other operations described herein.

As indicated above, FIG. 1 is provided as an example. Other examples may differ from what is described with regard to FIG. 1.

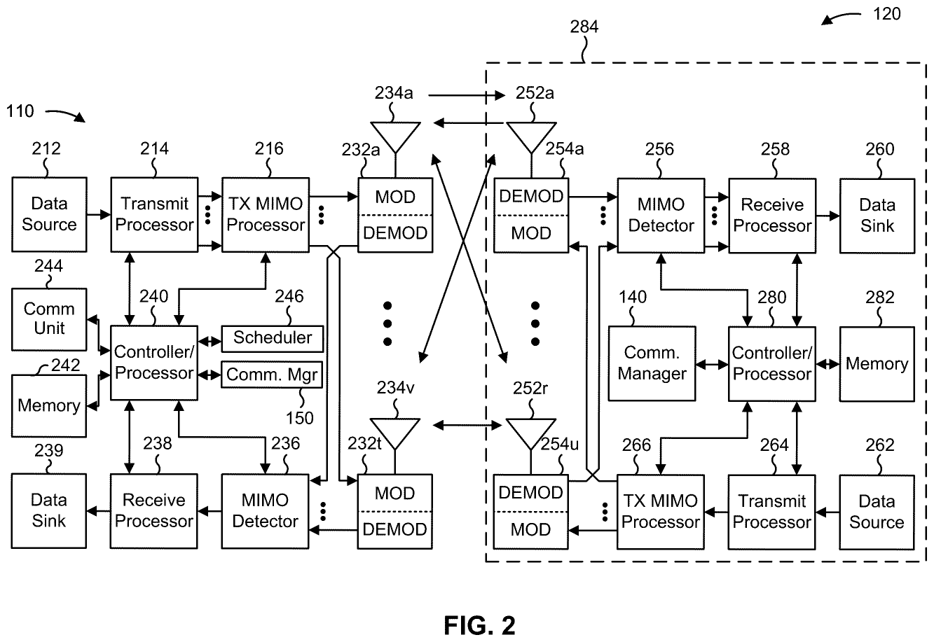

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more modulation and coding scheme (MCSs) for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC-CE communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

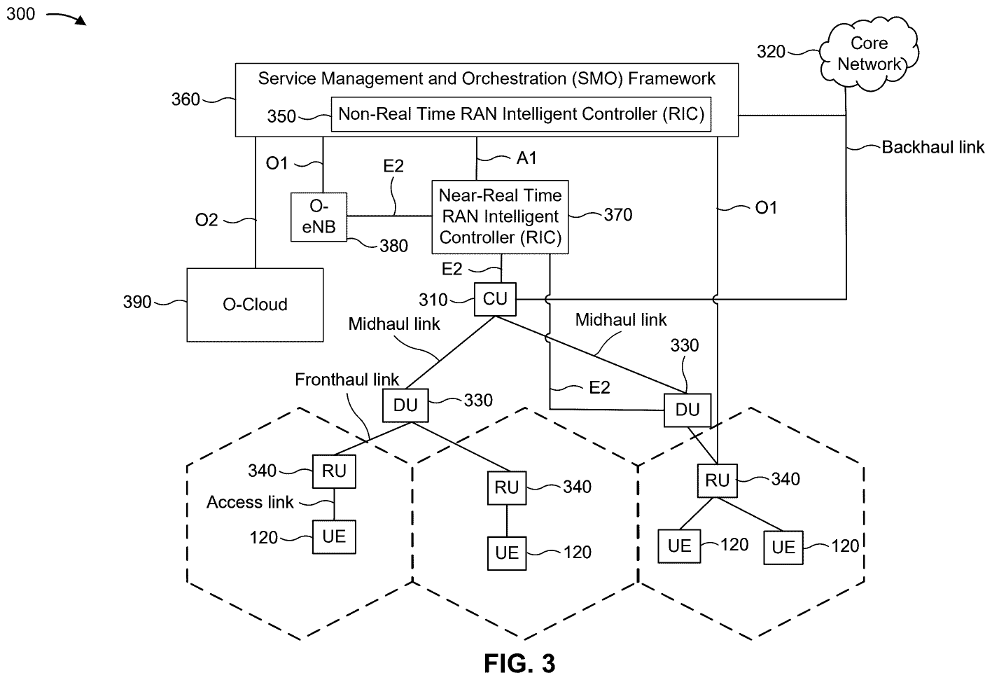

FIG. 3 is a diagram illustrating an example disaggregated base station architecture 300, in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUS 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-cNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

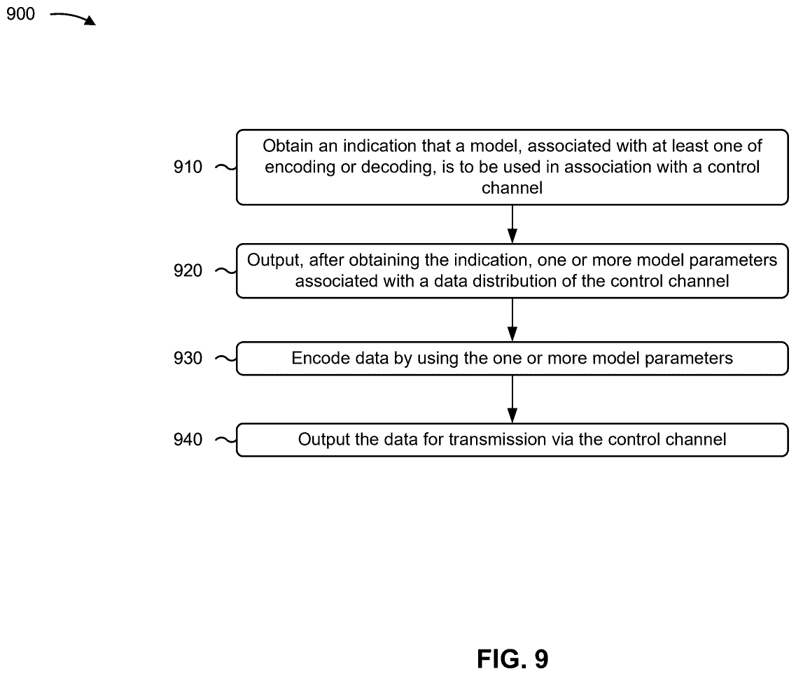

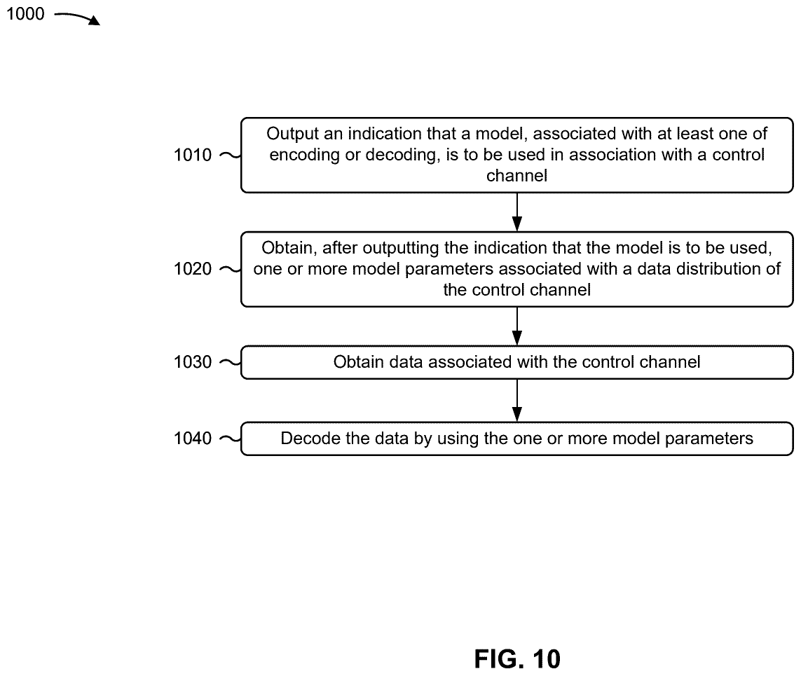

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with model management for control channel encoding or decoding, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 900 of FIG. 9, process 1000 of FIG. 10, or other processes as described herein (alone or in conjunction with one or more other processors). In some aspects, the wireless node described herein is the network node 110, is included in the network node 110, and/or includes one or more components of the network node 110 shown in FIG. 2. Additionally, or alternatively, the wireless node described herein is the UE 120, is included in the UE 120, and/or includes one or more components of the UE 120 shown in FIG. 2. For example, as used herein, “wireless node” refers to the network node 110 or the UE 120.

The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 900 of FIG. 9, process 1000 of FIG. 10, or other processes as described herein. In some examples, executing instructions may include running the instructions, converting the instructions, compiling the instructions, and/or interpreting the instructions, among other examples.

In some aspects, the UE 120 includes means for obtaining an indication that a model, associated with at least one of encoding or decoding, is to be used in association with a control channel; means for outputting, after obtaining the indication, one or more model parameters associated with a data distribution of the control channel; means for encoding data by using the one or more model parameters; and/or means for outputting the data for transmission via the control channel. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some examples, means for transmitting or sending may include a transceiver and/or one or more antennas of UE 120 described in connection with FIG. 2. In some examples, means for receiving may include a transceiver and/or one or more antennas the UE 120 described in connection with FIG. 2.

Means for obtaining, means for determining, means for performing, means for estimating, means for training, means for processing, means for encoding, means for identifying, means for selecting, means for training, means for resetting, means for detecting, and/or means for outputting may include one or more processors or components of the UE 120 described above in connection with FIG. 2, such as one or more of communication manager 140, modem 254, MIMO detector 256, receive processor 258, transmit processor 264, TX MIMO processor 266, controller/processor 280, memory 282, or a combination thereof.

In some aspects, the network node 110 includes means for outputting an indication that a model, associated with at least one of encoding or decoding, is to be used in association with a control channel; means for obtaining, after outputting the indication that the model is to be used, one or more model parameters associated with a data distribution of the control channel; means for obtaining data associated with the control channel; and/or means for decoding the data by using the one or more model parameters. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

In some examples, means for transmitting or sending may include a transceiver and/or one or more antennas of the network node 110 described in connection with FIG. 2. In some examples, means for receiving may include a transceiver and/or one or more antennas of the network node 110 described in connection with FIG. 2.

Means for obtaining, means for performing, means for estimating, means for decoding, means for training, means for processing, means for identifying, means for selecting, means for training, means for resetting, means for detecting, and/or means for outputting may include one or more processors or components of the network node 110 described above in connection with FIG. 2, such as such as one or more of communication manager 150, one or more antennas 234, modem 232, TX MIMO processor 216, transmit processor 214, or a combination thereof.

As indicated above, FIG. 3 is provided as an example. Other examples may differ from what is described with regard to FIG. 3.

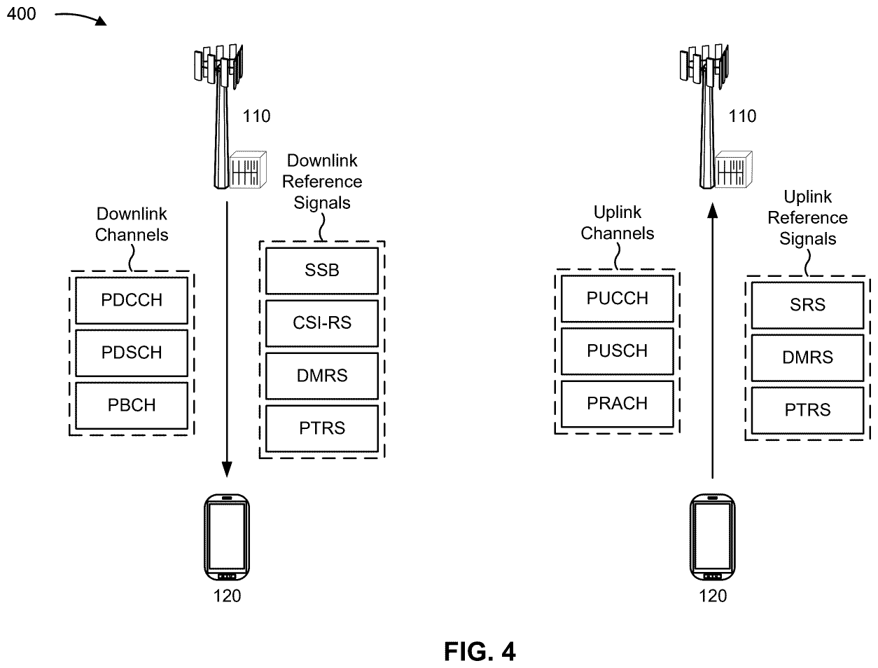

FIG. 4 is a diagram illustrating an example 400 of physical channels and reference signals in a wireless network, in accordance with the present disclosure. As shown in FIG. 4, downlink channels and downlink reference signals may carry information from a network node 110 to a UE 120, and uplink channels and uplink reference signals may carry information from a UE 120 to a network node 110.

As shown, a downlink channel may include a PDCCH that carries DCI, a PDSCH that carries downlink data, or a physical broadcast channel (PBCH) that carries system information, among other examples. In some aspects, PDSCH communications may be scheduled by PDCCH communications. As further shown, an uplink channel may include a PUCCH that carries UCI, a PUSCH that carries uplink data, or a PRACH used for initial network access, among other examples. In some aspects, the UE 120 may transmit ACK or NACK feedback (e.g., ACK/NACK feedback or ACK/NACK information) in UCI on the PUCCH and/or the PUSCH. The feedback may be HARQ feedback for data transmitted via the PDSCH or another downlink channel.

As further shown, a downlink reference signal may include a synchronization signal block (SSB), a CSI-RS, a DMRS, a positioning reference signal (PRS), or a phase tracking reference signal (PTRS), among other examples. As also shown, an uplink reference signal may include an SRS, a DMRS, or a PTRS, among other examples.

An SSB may carry information used for initial network acquisition and synchronization, such as a PSS, an SSS, a PBCH, and a PBCH DMRS. An SSB is sometimes referred to as a synchronization signal/PBCH (SS/PBCH) block. In some aspects, the network node 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The network node 110 may configure a set of CSI-RSs for the UE 120, and the UE 120 may measure the configured set of CSI-RSs. Based at least in part on the measurements, the UE 120 may perform channel estimation and may report channel estimation parameters to the network node 110 (e.g., in a CSI report), such as a CQI, a precoding matrix indicator (PMI), a CSI-RS resource indicator (CRI), a layer indicator (LI), a rank indicator (RI), or an RSRP, among other examples. The network node 110 may use the CSI report to select transmission parameters for downlink communications to the UE 120, such as a number of transmission layers (e.g., a rank), a precoding matrix (e.g., a precoder), an MCS, or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the network node 110 to improve observed time difference of arrival (OTDOA) positioning performance. For example, a PRS may be a pseudo-random quadrature phase shift keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring network nodes in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the network node 110 may then calculate a position of the UE 120 based on the RSTD measurements reported by the UE 120.

An SRS may carry information used for uplink channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network node 110 may measure the SRSs, may perform channel estimation based at least in part on the measurements, and may use the SRS measurements to configure communications with the UE 120.

The UE 120 and the network node 110 may support retransmissions of data to increase the likelihood that data is received successfully. HARQ feedback is one technique for increasing the likelihood that data is received correctly via a communication link or channel. HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise ratio conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The UE 120 may receive downlink signaling from the network node 110. The UE 120 may transmit feedback messages for the downlink signaling. For example, the UE 120 may transmit a feedback codebook (e.g., a sequence of bits that indicate feedback for one or multiple downlink transmissions), such as a HARQ ACK or NACK codebook including feedback bits indicating ACK or NACK information for the received downlink signaling. The UE 120 may transmit the feedback (e.g., the feedback codebook) via an uplink channel, such as the PUCCH. In some examples, the UE 120 may be more likely to transmit an ACK indication (e.g., bit 0) than a NACK indication (e.g., bit 1). For example, at a 10% BLER in the PDSCH, the UE 120 may transmit 90% ACK indications and 10% NACK indications. However, current codebooks are designed for uniform probability of messages with equal likelihood of the bit 0 and bit 1, and power is applied uniformly to the non-uniform messages. This results in inefficient power utilization.

Therefore, in some examples, the UE 120 and/or the network node 110 may use a power shaping scheme for encoding and decoding control channel communications, such as data transmitted via the PUCCH. As described in more detail elsewhere herein, the power shaping scheme may be associated with the UE 120 determining a transmit power for codewords included in a codebook using a set of power shaping parameters. The set of power shaping parameters may be associated with respective codewords of the codewords included in a codebook. In other words, each codeword may have a dedicated power shaping parameter that has a value that is based on, or otherwise associated with, a probability of occurrence of that codeword, as described in more detail elsewhere herein.

As indicated above, FIG. 4 is provided as an example. Other examples may differ from what is described with regard to FIG. 4.

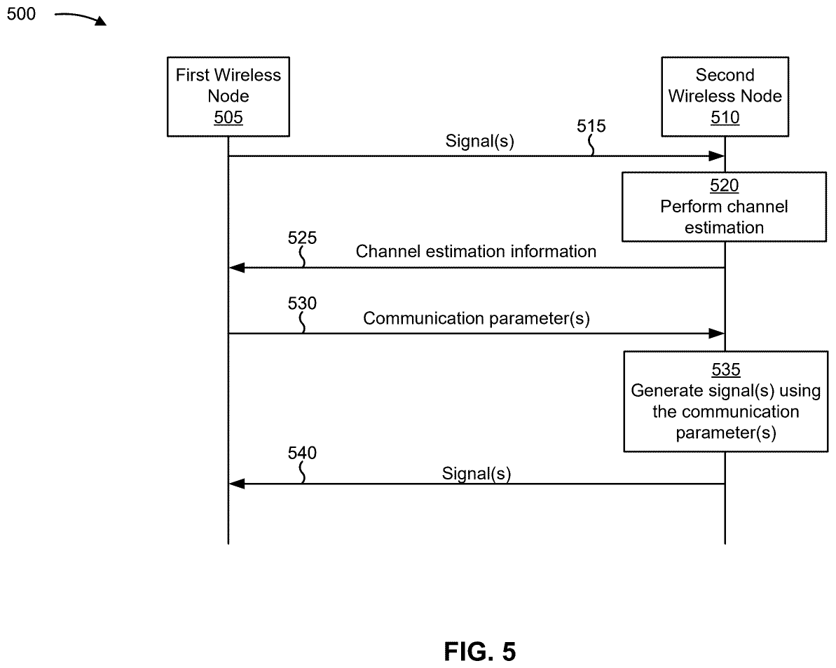

FIG. 5 is a diagram illustrating an example 500 of link adaptation, in accordance with the present disclosure. As shown in FIG. 5, a first wireless node 505 (e.g., a UE 120 or a network node 110) may communicate with a second wireless node 510 (e.g., a UE 120 or a network node 110). In some examples, the first wireless node 505 may be a network node 110, and the second wireless node 510 may be a UE 120. In other examples, the first wireless node 505 and the second wireless node 510 may be other types of wireless communication devices (e.g., both the first wireless node 505 and the second wireless node 510 may be UEs). The first wireless node 505 and the second wireless node 510 may communicate via a wireless communication network, such as the wireless communication network 100.

The first wireless node 505 and the second wireless node 510 may perform link adaptation to dynamically adjust communication parameters (e.g., transmission parameters) based on, in response to, or otherwise associated with, an estimated quality of a communication link, such as one or more communication channels (e.g., the PDSCH, the PUSCH, the PDCCH, and/or the PUCCH). For example, in a wireless communication network, channel conditions between the first wireless node 505 and the second wireless node 510 may vary due to one or more factors, such as a distance between the first wireless node 505 and the second wireless node 510, one or more obstacles in the environment (e.g., that may block or deflect transmitted beams or signals), and/or interference from other signals, among other examples. One example of link adaptation is outer-loop link adaptation (OLLA). Unlike inner-loop link adaptation, which adapts one or more parameters based on short-term variations in a channel, OLLA enables parameter adaptation based on longer-term variations, making OLLA more suitable for optimizing system performance over time.

For example, as shown by reference number 515, the first wireless node 505 may transmit, and the second wireless node 510 may receive, one or more signals. The one or more signals may include one or more reference signals, data signals, control signals, and/or other types of signals. The one or more signals may be transmitted via a communication channel, such as the PDSCH, the PDCCH, the PUSCH, and/or the PUCCH. As shown by reference number 520, the second wireless node 510 may perform channel estimation based on, or using, the one or more signals. For example, the second wireless node 510 may decode, measure, and/or otherwise process the one or more signals to estimate one or more channel estimation parameters. In some examples, the second wireless node 510 may determine CSI based on measuring and/or otherwise processing the one or more signals. The one or more channel estimation parameters may include one or more CSI parameters, a CQI parameter, an RSRP parameter, an RSSI parameter, an RSRQ parameter, a TPC parameter, and/or another parameter.

As shown by reference number 525, the second wireless node 510 may transmit, and the first wireless node 505 may receive, channel estimation information (e.g., for the channel via which the one or more signals were transmitted as described in connection with reference number 515). The channel estimation information may include the one or more channel estimation parameters and/or CSI for the channel. For example, the channel estimation information may be included in a CSI report.

The first wireless node 505 may determine, adjust, and/or set one or more communication parameters to be used by the second wireless node 510 based on the channel estimation information. For example, the first wireless node 505 may determine an appropriate MCS to be used by the second wireless node 510 based on the channel estimation information. As another example, the first wireless node 505 may determine a transmit power, one or more power control parameters, and/or a frame structure, among other examples, based on the channel estimation information. In some examples, the first wireless node 505 may determine, adjust, and/or set one or more communication parameters to maintain or achieve a target error rate for data (e.g., a payload) transmitted via the channel (e.g., a target BLER). For example, the first wireless node 505 may determine, adjust, and/or set one or more communication parameters based on the channel estimation information and/or based on feedback from the second wireless node 510 (e.g., HARQ feedback) to maintain or achieve the target error rate.

As shown by reference number 530, the first wireless node 505 may transmit, and the second wireless node 510 may receive, the one or more communication parameters, such as an MCS, a transmit power, one or more power control parameters, among other examples. For example, the first wireless node 505 may configure the second wireless node 510 to use the one or more communication parameters. As shown by reference number 535, the second wireless node 510 may generate one or more signals using the one or more communication parameters. As shown by reference number 540, the second wireless node 510 may transmit, and the first wireless node 505 may receive, the one or more signals (e.g., that were generated using the one or more communication parameters).

In some examples, the second wireless node 510 may transmit, and the first wireless node 505 may receive, feedback information. The feedback information may include HARQ feedback and/or a feedback codebook. In the context of feedback information (e.g., HARQ feedback), “codebook” refers to a set of one or more (e.g., a matrix of one or more) feedback indications (e.g., ACK or NACK indications) that can be transmitted via a single transmission (e.g., a single uplink transmission, such as via the PUCCH or the PUSCH). In some cases, a wireless node (e.g., a UE) may support HARQ feedback codebook transmissions. A HARQ feedback codebook transmission may include a feedback message that the network entity is to transmit to another network entity to provide feedback regarding, for example, downlink data transmission (for example, transmissions associated with a PDSCH). The network entity may be configured with different types of codebooks, such as a Type-1 HARQ ACK codebook or a Type-2 HARQ ACK codebook. For example, the Type-1 HARQ ACK codebook may be associated with a fixed, or static, size (for example, that is configured by the network entity). The Type-2 HARQ ACK codebook may be associated with a dynamic size (for example, where the size of the Type-2 HARQ ACK codebook is based at least in part on, or otherwise associated with, scheduling received by the network entity). Typically, if the network entity is configured to transmit a Type-1 HARQ ACK codebook, the network entity may collect feedback for one or more communications (e.g., PDSCH communications) that are received by the network entity during a feedback window (for example, k time intervals, such as k slots, k subframes, or k symbols), and may transmit the Type-1 HARQ ACK codebook indicating feedback (for example, ACK/NACK feedback) associated with the PDSCH communications that are received by the network entity during the feedback window. As used herein, a codebook may be a sequence of bits, which may be constructed using ACK/NACK feedback associated with multiple communications (e.g., multiple PDSCH communications) that are received by a network entity during a feedback window. A codebook may include one or more codewords. A codeword may include a message or communication. For example, a codeword may include one or more ACK/NACK feedback indications (e.g., a sequence of one or more HARQ ACK bit values and/or HARQ NACK bit values).

As described elsewhere herein, the first wireless node 505 may configure one or more communication parameters to achieve a target error rate for a given channel, such as the PDSCH. The second wireless node 510 may transmit, and the first wireless node 505 may receive, a codebook indicating feedback (e.g., HARQ ACK/NACK feedback) for the given channel. Because the communication parameter(s) are configured to achieve the target error rate (e.g., target BLER) for the given channel, the feedback information for the given channel will be biased and/or non-uniform. For example, if the target BLER for the PDSCH is 10%, then the probability that feedback is ACK feedback is 90% for a given communication (e.g., a given transport block) transmitted via the PDSCH. In some examples, codebooks may be designed for uniform probability of messages with equal likelihood of the bit 0 and bit 1. In such examples, power is applied uniformly to all codewords in the codebook. For example, each codeword may be transmitted using the same transmit power. This results in inefficient power usage by the network entity transmitting the codebook.

In some examples, a network entity may utilize techniques for power shaping associated with non-uniform message transmissions to improve power savings. For example, more power may be proportionally assigned to less likely symbols (e.g., less likely codewords) and less power to more likely symbols (e.g., more likely codewords) to reduce the average transmit power and improve error performance. For example, the network entity may scale a power of a codeword based on, or otherwise associated with, a probability associated with the codeword. As an example, the network entity (e.g., the second wireless node 510) may perform a power scaling procedure for the codeword c (x*) based on a power scaling parameter. In some examples, the second wireless node 510 may receive the power scaling parameter from the first wireless node 505. In some examples, the power scaling parameter may be associated with a non-uniform probability of respective portions of the message x^{k}. For example, the power scaling procedure may use a scaling parameter of

$$log ( \frac{1}{p ( {x}^{k} )} ) ,$$

where p (x^{k}) is the non-uniform probability of the message x^{k}. The message x^{k} may include one or more feedback indications, such as HARQ ACK indications or HARQ NACK indications, among other examples. In other words, if a codeword c has probability π_{c}, then the transmit power allocated to that codeword may be proportional to the probability associated with the codeword (e.g., P_{c}∝−log π_{c}, where P_{c} is a power shaping parameter).

In some examples, techniques for power control for ACK/NACK transmission may scale power according to the probability of a message sequence. For example, if the message sequence x^{k} has probability p (x^{k}), then the power of the corresponding codeword transmission c (x^{k}) may be scaled with

$$log ( \frac{1}{p ( {x}^{k} )} ) .$$

After normalization with respect to unit expected power over the whole codebook, message sequence x^{k} may be mapped to

$$\sqrt{log ( \frac{1}{p ( {x}^{k} )} ) * \frac{1}{{\sum }_{{x}^{k}} p ( {x}^{k} ) log ( \frac{1}{p ( {x}^{k} )} )}} * c ( {x}^{k} ) ,$$

where the normalization parameter α is

$$\frac{1}{{\sum }_{{x}^{k}} p ( {x}^{k} ) log ( \frac{1}{p ( {x}^{k} )} )} .$$

Techniques for power control for the message comprising independent and identically distributed bit values may scale power according to the probability of a message sequence. If all bits are independent and identically Bernoulli distributed (Bern (p)), the probability may be p(x^{k})=p^{m} (1−p)^{k-m}, where p denotes a probability of bit 1, m denotes a quantity of bit 1 in the message x^{k}, and k denotes the message length. In some cases, the normalization parameter may be simplified to

$$α = {\sum }_{{x}^{k}} p ( {x}^{k} ) log ( \frac{1}{p ( {x}^{k} )} ) = \frac{1}{k H ( p )} ,$$

where H (p)=−p log (p)−(1−p) log (1−p) is the entropy of Bern (p) variable and may be precomputed for a given value of p. The power scaling may be simplified to

$$α * log ( \frac{1}{p ( {x}^{k} )} ) = \frac{1}{k * H ( p )} log ( \frac{1}{p ( {x}^{k} )} ) .$$

In some examples, techniques for power control for the message comprising bits having non-identically distributed bit values may scale power according to the probability of a message sequence. In some cases, the bits may correspond to different types of contents. For example, a subset of message bits may correspond to HARQ-ACK and another subset may correspond to a scheduling request (SR).

In some examples, the probabilities of respective codewords included in the codebook (e.g., included in control channel data) may vary over time. Therefore, using a given encoder (e.g., the same encoder) to encode the control channel data (e.g., using a given codebook and given set of power shaping parameters) may result in degraded communication performance in some examples. For example, the encoder may be configured or designed to improve performance of control channel transmissions for a given data distribution (e.g., a probability distribution for codewords) associated with the control channel transmissions. As the data distribution associated with the control channel may change over time, a performance of control channel transmission transmitted by the wireless node (e.g., that are encoded using the encoder) may be degraded in some cases, such as when the data distribution differs from the data distribution that was used to configure or design the encoder. Additionally, for some data distributions of the control channel and/or for some conditions (e.g., channel conditions and/or wireless node conditions), the power-shaping-based encoding described herein may result in degraded performance as compared to an encoding operation that does not use a power shaping scheme. However, wireless nodes (e.g., a UE and/or a network node) may not be synchronized as to the current data distribution (e.g., probability distribution) associated with the control channel (e.g., a first wireless node may estimate the data distribution, but a second wireless node may not obtain or determine the data distribution). Therefore, modifying the encoding and/or decoding scheme (e.g., as the data distribution changes) may result in errors (e.g., decoding errors) and/or failed communications, among other examples.

As indicated above, FIG. 5 is provided as an example. Other examples may differ from what is described with regard to FIG. 5.

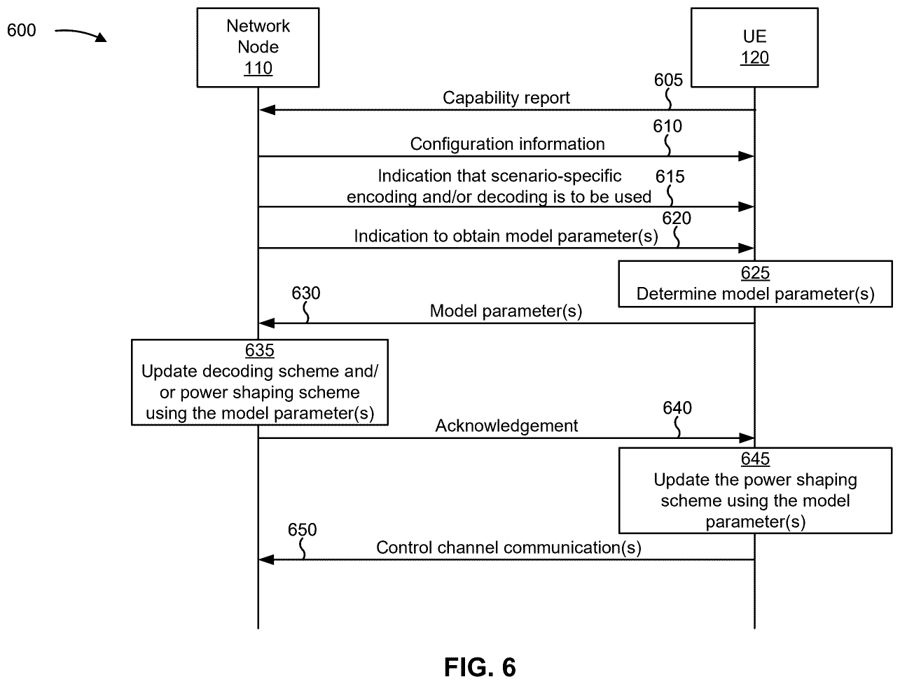

FIG. 6 is a diagram of an example 600 associated with model management for control channel encoding or decoding, in accordance with the present disclosure. As shown in FIG. 6, a network node 110 (e.g., a wireless node, a CU, a DU, and/or an RU) may communicate with a UE 120 (e.g., a wireless node). In some aspects, the network node 110 and the UE 120 may be part of a wireless network (e.g., the wireless network 100). The UE and the network node may have established a wireless connection prior to operations shown in FIG. 6.

Although some examples are described herein in connection with uplink control channel communications, the techniques described herein (such is in connection with FIGS. 6-10) may be similarly applied to other types of communications that use codebooks associated with per-codeword power shaping (e.g., sidelink communications, downlink communications, peer-to-peer communications, machine-type communications, or other types of communications). In examples where the techniques described herein are performed in association with a sidelink channel, the UE 120 may transmit the one or more model parameters described herein to another UE 120 (not shown in FIG. 6), rather than to the network node 110 (e.g., as shown in FIG. 6 and by reference number 630, described in more detail elsewhere herein).

In some aspects, as shown by reference number 605, the UE 120 may transmit (e.g., output for transmission), and the network node 110 may receive (e.g., obtain), a capability report. The UE 120 may transmit the capability report via an uplink communication, a UE assistance information (UAI) communication, a UCI communication, an uplink MAC-CE communication, an RRC communication, a PUCCH (e.g., a PUCCH communication), and/or a PUSCH (e.g., a PUSCH communication), among other examples. The capability report may include capability information indicative of one or more capabilities of the UE 120. The capability report may indicate one or more parameters associated with respective capabilities of the UE 120. The one or more parameters may be indicated via respective information elements (IEs) included in the capability report.

The capability report may indicate whether the UE 120 supports a feature and/or one or more parameters related to the feature. The capability report may indicate whether the UE 120 supports one or more operations described herein. For example, the capability report may indicate a capability and/or parameter for supporting data distribution model parameter signaling associated with a channel (e.g., an uplink control channel, such as the PUCCH). As another example, the capability report may indicate a capability and/or parameter for supporting a per-codeword power shaping codebook for the channel. One or more operations described herein may be based on, or otherwise associated with, capability information of the capability report. For example, the UE may perform a communication in accordance with the capability information, or may receive configuration information that is in accordance with the capability information. In some aspects, the capability report may indicate UE support for using a model to determine (or predict) the data distribution (e.g., probability distribution) for a control channel (e.g., a probability distribution of codewords included in a codebook associated with the control channel). The capability report may indicate UE support for outputting for transmission one or more model parameters that are indicative of the data distribution for the control channel. In some aspects, the capability report may indicate UE support for scenario-specific (e.g., data-distribution-specific) encoding schemes associated with the control channel. For example, the capability report may indicate UE support for modifying or determining a power shaping scheme (e.g., for calculating one or more power shaping parameters for respective codewords) using the model and/or the one or more model parameters. The capability report may indicate UE support for one or more (e.g., any) operations (e.g., performed by the UE 120) described herein.

In some aspects, the UE 120 may output for transmission, and the network node 110 may obtain, an updated capability report for the UE 120 (e.g., after the UE 120 transmits the capability report described above). For example, one or more capabilities of the UE 120 may be based on one or more conditions being met. The one or more conditions may include a battery level condition, a signal parameter condition (e.g., a signal strength condition or a signal quality condition), and/or a mobility condition, among other examples. For example, if the battery level does not satisfy a threshold, then the UE 120 may not support one or more capabilities, such as determining or outputting the one or more model parameters described herein. In such examples, the UE 120 may output for transmission, and the network node 110 may obtain, an updated capability report indicating one or more updated capabilities of the UE 120.

As shown by reference number 610, the network node may output for transmission (e.g., transmit), and the UE may obtain (e.g., receive), configuration information. In some aspects, the UE may receive the configuration information via one or more of system information signaling (e.g., a master information block (MIB) and/or a system information block (SIB), among other examples), RRC signaling, MAC signaling (e.g., one or more MAC-CEs), and/or DCI signaling, among other examples.

In some aspects, the configuration information may indicate one or more candidate configurations and/or communication parameters (e.g., scenario-specific encoding and/or decoding or default encoding and/or decoding for the control channel). In some aspects, the one or more candidate configurations and/or communication parameters may be selected, activated, and/or deactivated by a subsequent indication (e.g., such as described in connection with reference number 615 and/or reference number 620). For example, the subsequent indication may select a candidate configuration and/or communication parameter from the one or more candidate configurations and/or communication parameters. In some aspects, the subsequent indication (e.g., an indication described herein, such as in connection with reference number 615 and/or reference number 620) may include a dynamic indication, such as one or more MAC-CEs and/or one or more DCI messages, among other examples.

In some aspects, the configuration information may indicate that the UE 120 is to output (e.g., transmit) an indication of one or more model parameters for a data distribution model. The one or more model parameters may be indicative of a data distribution (e.g., a probability distribution) for a control channel (e.g., for an uplink control channel). The data distribution may include a relative frequency associated with one or more codewords in the codebook over a time interval (e.g., where the time interval is between RRC reconfigurations associated with the model and/or between switches between models, as described in more detail elsewhere herein). The model may include an autoregressive model, a transformer, or another model configured to output an inference or prediction of a probability of occurrence for one or more codewords. In some aspects, the configuration information may indicate the model to be used by the UE 120. In other aspects, the model to be used by the UE 120 may be defined, or otherwise fixed, by a wireless communication standard, such as the 3GPP.

In some aspects, the configuration information may indicate that the UE 120 is to communicate (e.g., transmit) uplink control channel communications using the per-codeword power shaping codebook. For example, the configuration information may include a configuration for the uplink control channel (e.g., a PUCCH configuration). The configuration information may configure one or more uplink control channel (e.g., PUCCH) rate tuples rᵢ=(kᵢ, nᵢ), where kᵢ is a quantity of information bits, and nᵢ is the quantity of resources allocated for PUCCH transmission (e.g., quantity of frequency domain resources (e.g., subcarriers, resource blocks, and/or resource elements)) and/or quantity of time domain resources (e.g., symbols).

For each PUCCH rate tuple, the configuration information may indicate a codebook. The codebook may be a per-codeword power shaping codebook. In other words, the codebook may be associated with power shaping parameters for respective codewords included in the codebook (e.g., each codeword may have a separate or dedicated power shaping parameter to define a power to be allocated to that codeword). For example, the codebook may be represented as

$${𝒞}_{i} = [ \sqrt{{P}_{i , 1}} {c}_{i , 1} , … , \sqrt{{P}_{i , {2}^{k}}} {c}_{i , {2}^{k} i} ] ,$$

where P_{i,j} represents the power shaping parameter for the codebook i and the codeword j, and c_{i,j} represents the codeword j for the codebook i, where the codebook i includes 2^{k} codewords (e.g., where k is the quantity of information bits for the codebook i). [symbol] ᵢ may also be referred to herein as an encoder. For example, the encoder may include a codebook [c_{i,1}, . . . , c_{i,2}_{^{k}}ᵢ] and a power shaping scheme that includes one or more power shaping parameters [P_{i,1}, . . . , P_{i,2}_{^{k}}].

As described elsewhere herein, a value of a power shaping parameter (e.g., P_{i,j}) may be configured or determined based on, or otherwise associated with, a probability of a corresponding codeword being included in a PUCCH communication. For example, the UE 120 may transmit the codebook i via one or more uplink control channel communications (e.g., in PUCCH data). The PUCCH data may include M unique codewords from the codebook i, where

$$M \leq {\sum }_{i} {2}^{{k}_{i}} .$$

The UE 120 may configure itself based at least in part on the configuration information. In some aspects, the UE 120 may be configured to perform one or more operations described herein based at least in part on the configuration information.

In some aspects, the configuration information described in connection with reference number 610 and/or the capability report described in connection with reference number 605 may include information transmitted via multiple communications. Additionally, or alternatively, the network node 110 may transmit the configuration information, or a communication including at least a portion of the configuration information, before and/or after the UE 120 transmits the capability report. For example, the network node 110 may transmit a first portion of the configuration information before the UE 120 transmits the capability report, the UE 120 may transmit at least a portion of the capability report, and the network node 110 may transmit a second portion of the configuration information after receiving the capability report.

As shown by reference number 615, the UE 120 may receive, and the network node may transmit, an indication that scenario-specific encoding and/or decoding is to be used for the control channel (e.g., the uplink control channel). For example, the network node 110 may output for transmission, and the UE 120 may obtain, an indication that a model, associated with encoding and/or decoding, is to be used in association with a control channel. The model may be a data distribution model configured or trained to output an inference or prediction of a probability of a next bit in a sequence of bits comprising a message to be encoded. For example, the model may be configured to predict a next data value in a sequence of control channel data. The model may include an autoregressive model, a transformer, or another type of model. In some aspects, the indication shown by reference number 615 may include an indication of the model to be used by the UE 120.

The indication that scenario-specific encoding and/or decoding is to be used for the control channel may be communicated via RRC signaling, MAC signaling, and/or DCI signaling, among other examples. For example, the network node 110 may output for transmission, and the UE 120 may obtain, one or more RRC configuration communications that include the indication that scenario-specific encoding and/or decoding is to be used for the control channel. For example, an RRC configuration communication may include information (e.g., a parameter or IE) indicating that the model is to be used to indicate the data distribution for the control channel.

In some aspects, after obtaining the indication that scenario-specific encoding and/or decoding is to be used for the control channel, the UE 120 may output for transmission one or more control channel communications (e.g., using another encoding scheme, such as a default encoding scheme or a non-power-shaping encoding scheme). For example, the UE 120 may encode the one or more control channel communications using a codebook that uses a power control parameter that is common to all codewords in the codebook (e.g., rather than the power shaping scheme that uses dedicated power shaping parameters for each codeword). Alternatively, the UE 120 may encode the one or more control channel communications using the power shaping scheme.

In some aspects, based on, after, in response to, or otherwise associated with obtaining the indication that scenario-specific encoding and/or decoding is to be used for the control channel, the UE 120 may track, maintain, and/or store an indication of the data (e.g., historical data or previously transmitted data) included in the one or more control channel communications. For example, the data (e.g., historical data or previously transmitted data) may be used by the UE 120 to determine one or more model parameters of the model, as described elsewhere herein (such as in connection with reference number 625).

The UE 120 may configure itself, based at least in part on, or after, receiving (e.g., obtaining) the indication described in connection with reference number 615 to use the model to determine or indicate the data distribution for the control channel. For example, the UE 120 may configure itself to track, maintain, and/or store an indication of the data (e.g., historical data or previously transmitted data) included in the one or more control channel communications.

As shown by reference number 620, the network node 110 may output for transmission, and the UE 120 may obtain, an indication to obtain one or more model parameters. For example, the indication described in connection with reference number 620 may indicate that the UE 120 is to update or modify an encoding scheme used for the control channel. For example, the indication described in connection with reference number 620 may cause or trigger the UE 120 to determine (e.g., calculate) one or more model parameters for the model. The indication to obtain one or more model parameters may be communicated via RRC signaling, MAC signaling, and/or DCI signaling, among other examples. For example, the network node 110 may output for transmission, and the UE 120 may obtain, one or more RRC configuration communications that include the indication to obtain one or more model parameters. As an example, the indication to obtain one or more model parameters may be included in an RRC reconfiguration (e.g., RRCReconfiguration) communication. For example, the RRC reconfiguration communication may include information (e.g., a parameter or IE) indicating that the UE 120 is to update the encoding scheme used for the control channel and/or indicating that the UE 120 is to output or transmit an indication of the one or more model parameters.

For example, the network node 110 may output, and the UE 120 may obtain, a first communication indicating that the model is enabled for use. The first communication may include the indication described in connection with reference number 615. The first communication may cause the UE 120 to begin tracking a data distribution (e.g., a probability distribution of codewords) associated with the control channel. Additionally, or alternatively, the network node 110 may output, and the UE 120 may obtain, a second communication indicating that the model is to be reconfigured for the control channel. The second communication may include the indication described in connection with reference number 620. The second communication may cause the UE 120 to determine and/or output for transmission (e.g., transmit) the one or more model parameters, as described herein, such as in connection with reference number 625.

As shown by reference number 625, the UE 120 may determine the one or more model parameters. The UE 120 may determine the one or more model parameters using the model. The one or more model parameters may be associated with a data distribution of the control channel over a time interval. For example, the data distribution includes a relative frequency (e.g., frequency of transmission) associated with one or more codewords in the codebook over the time interval. The time interval may be an amount of time between reconfigurations and/or switches associated with the encoding and decoding scheme for the control channel. As another example, the time interval may be an amount of time between reconfigurations and/or switches associated with the model (or multiple models including the model). For example, the time interval may be between a first time (e.g., at which the indication described in connection with reference number 615 is received or obtained by the UE 120) and a second time (e.g., at which the indication described in connection with reference number 620 is received or obtained by the UE 120). For example, the time interval may be a time interval between the model being configured for use and a reconfiguration of the model. As another example, the time interval may be a time interval between a first reconfiguration of the model and a second reconfiguration of the model (e.g., RRC reconfigurations and/or MAC-CE initiated model switches).

In some aspects, the codewords included in the one or more control channel communications may have the same size (e.g., the same payload length). In other aspects, the codewords included in the one or more control channel communications may have different sizes (e.g., different payload lengths). In examples where the codewords have the same size, a first type of model may be used by the UE 120. In examples where the codewords have different sizes, a second type of model may be used by the UE 120. For example, the first type of model may be an autoregressive model (e.g., which may have reduced processing overhead and/or signaling overhead as compared to other types of models). For example, an assumption of the first type of model may include the size of the codeword being the same for each codeword. The second type of model may be a transformer (e.g., which may be associated with improved flexibility and/or performance for codewords having different sizes).

In some aspects, the UE 120 may train the model using the data distribution (e.g., of the control channel) over the time interval. For example, the UE 120 may train or estimate (e.g., fit) one or more model parameters of the model using the data distribution. For example, the UE 120 may determine best possible values of respective model parameters to improve the inference performance of the model. The inference performance may be associated with an accuracy of a prediction of a next data value (e.g., a next HARQ-ACK data value) in a series of uplink control channel data. The one or more model parameters may include an order parameter (e.g., indicating an order of the model), one or more coefficients (e.g., having respective weights), an error variance, one or more correlation parameters (e.g., indicating a correlation between a current observation and one or more previous or lagged values), an embedding dimension, a quantity of attention heads, a feed-forward network dimension, and/or a classification token, among other examples.

For example, the model may include an autoregressive model. An order of the autoregressive model may be one, two, or another value. The UE 120 may determine the data distribution or probability distribution for one or more codewords included in a given codebook (e.g., for the time interval described above). For example, the UE 120 may set a probability for any codewords that were not included in any of the control channel communications during the time interval to zero. The data distribution may include probabilities for respective codewords included in the codebook. For example, the data distribution may be Π=[π₁, . . . , π_{M}], where Π is the data distribution, where there are M codewords included in the codebook, and where πᵢ is the probability of occurrence for an i^{th} codeword included in the codebook. The UE 120 may train or estimate (e.g., fit) the model to the data distribution (e.g., Il). The model parameter(s) of the model that is fit to the data distribution may be the one or more model parameters.

For example, the autoregressive model may be a time series model where a current value (e.g., a codeword) is predicted based on past values (e.g., past values of codewords). Fitting an autoregressive model to data may include the UE 120 estimating coefficients of the autoregressive model. The coefficients may represent the influence of past observations on a current observation. The one or more model parameters may include the coefficient(s) of the autoregressive model. The UE 120 may estimate the coefficient(s) using ordinary least squares (OLS) regression, and/or or maximum likelihood estimation (MLE), among other examples.

In some aspects, the autoregressive model may have an order of one. In such examples, the one or more model parameters may include a message type probability (e.g., an ACK probability) and a coefficient parameter. The ACK probability may be a fixed value (e.g., based on the BLER for the downlink data channel (e.g., the PDSCH)). The coefficient parameter may indicate a strength or relation (e.g., an impact) of a previous observation (e.g., a previous information bit) on a current observation (e.g., a current information bit). For example, a conditional probability of a current bit being an ACK value when a previous bit was an ACK value may be p+ρ(1−p), where p is the ACK probability and ρ is the coefficient parameter. Similarly, the conditional probability of a current bit being an NACK value when a previous bit was an NACK value may be (1−p)+ρp. Using the above assumptions, the UE 120 may determine a probability of occurrence for k bits included in a control channel message. For example, for an autoregressive model having an order of one, the UE 120 may fit the model as

$$π ( {b}_{0} , … {b}_{k - 1} ) = p ( {b}_{0} ) {\prod }_{i = 1}^{k - 1} P ( {b}_{i} \vert {b}_{i - 1} ) ,$$

where the total quantity of data bits in an uplink control channel communication is k, where bᵢ is the i^{th} bit in the uplink control channel communication, and where P (bᵢ|bᵢ₋₁) is the probability of the i^{th} bit conditioned on a value of the previous bit. In such examples, the one or more model parameters may include the ACK probability (e.g., p) and the coefficient parameter (e.g., ρ).

Similarly, for an autoregressive model having an order of two, the one or more model parameters may include two coefficient parameters, a first coefficient parameter (e.g., ρ₁) for a first previous bit and a second coefficient parameter (e.g., ρ₂) for a second previous bit that is previous to the previous bit. In such examples, the probability of a current bit and the two previous bits being ACK values may be p+ρ₂(1−p), a probability of a current bit being an ACK value, the previous bit being an ACK value, and the second previous bit being a NACK value may be p+ρ₁(1−p). Additionally, the probability of each of the three bits being NACK values may be (1−p)+ρ₂p, and a probability of the current bit and the first previous bit being NACK values and the second previous bit being an ACK value may be (1−p)+ρ₁p. Using the above assumptions, the UE 120 may determine the probabilities for a set of k bits (e.g., π(b₀, . . . bₖ₋₁)) the equation

$$π ( {b}_{0} , … {b}_{k - 1} ) = p ( {b}_{0} ) p ( {b}_{1} \vert {b}_{0} ) {\prod }_{i = 2}^{k - 1} P ( {b}_{i} \vert {b}_{i - 1} , {b}_{i - 2} ) .$$

In such examples, the one or more model parameters may include the ACK probability (e.g., p), the first coefficient parameter (e.g., ρ₁), and the second coefficient parameter (e.g., ρ₂).

As another example, the UE 120 may use a transformer to estimate the probabilities for a set of k bits (e.g., π(b₀, . . . bₖ₋₁)). The transformer may include, or may be, a neural network. Without assuming a value of k, the probabilities for a set of k bits may be

$$π ( {b}_{0} , … {b}_{k - 1} ) = p ( {b}_{0} ) {\prod }_{i = 1}^{k - 1} P ( {b}_{i} \vert {b}_{i - 1} , … {b}_{0} ) .$$

The UE 120 may train the transformer using an autoregressive operation (e.g., using the data distribution (e.g., Π)) to train the transformer to predict a value of a next bit in a sequence of bits. For example, the UE 120 may train the transformer using a ground truth target sequence (e.g., the data distribution Π) and can use one or more training operation to set one or more weights or architectures of the transformer to accurately predict a value of a next bit in a sequence of bits for the control channel. The transformer may enable the UE 120 to predict the probability for any size or sequence length of a codeword. If a transformer is used, the one or more model parameters may include one or more weights of layers (e.g., neural network layers) of the transformer, and/or one or more architecture parameters of the transformer (e.g., a quantity of layers), among other examples.

For example, the UE 120 may obtain, via the model and after training the model, the one or more model parameters. In some examples, the UE 120 may compress the one or more model parameters using a compression operation, such as an uplink compression operation. For example, if the one or more model parameters include one or more weights of layers (e.g., neural network layers) of the transformer, the UE 120 may compress the one or more weights to reduce the size of a communication that includes an indication of the one or more weights.

After determining the one or more model parameters, the UE 120 may reset the data distribution for the control channel. For example, the UE 120 may set the values included in the data distribution Π to zero. In other words, the UE 120 may, after determining and/or output (e.g., as shown by reference number 630) the one or more model parameters, reset the relative frequencies of respective codewords to zero. This enables the UE 120 to track and/or maintain a more accurate and/or recent data distribution of the control channel. For example, by resetting the relative frequencies of respective codewords to zero, the UE 120 may reduce the likelihood of older data transmitted via the control channel impacting the determination of future model parameter(s).

As shown by reference number 630, the UE 120 may output for transmission (e.g., transmit) and the network node 110 may obtain (e.g., receive), an indication of the one or more model parameters. The UE 120 may transmit the one or more model parameters using RRC signaling, MAC signaling, and/or UCI signaling. For example, the UE 120 may transmit the one or more model parameters via one or more MAC-CEs. In some examples, the UE 120 may transmit the one or more model parameters via the control channel (e.g., via a PUCCH transmission). Alternatively, the UE 120 may transmit the one or more model parameters via a data channel or a shared channel (e.g., via a PUSCH transmission). As described above, the UE 120 may reset the data distribution for the control channel after outputting the one or more model parameters.

As shown by reference number 635, the network node 110 may update a decoding scheme and/or power shaping scheme (e.g., for the control channel) using the one or more model parameters. For example, the network node 110 may determine and/or obtain, by using the one or more model parameters, a prior distribution for a decoder (e.g., a MAP-based decoder). The decoder may be used by the network node 110 to decode data included in control channel communications.

Additionally, or alternatively, the network node 110 may determine (e.g., calculate) values for one or more power shaping parameters using the one or more model parameters. For example, as described elsewhere herein, the encoder is associated with a codebook and a power shaping scheme. For example, the codebook may be a per-codeword power shaping codebook that is associated with power shaping parameters for respective codewords included in the codebook. The values of the power shaping parameters may be based on, or otherwise associated with, the one or more model parameters. In other words, for different model parameters, the network node 110 may determine or use different power shaping parameters. The network node 110 may determine the power shaping parameters in a similar manner as described elsewhere herein, such as in connection with FIG. 5. In some examples, the network node 110 may store a mapping of model parameter(s) to power shaping parameters. The network node 110 may use the mapping to determine the power shaping parameters for the power shaping scheme. By varying the power shaping parameters for different model parameters, the power shaping scheme may be tailored to the data distribution of the control channel, thereby improving the power efficiency of control channel communications.

As shown by reference number 640, the network node 110 may output (e.g., transmit), and the UE 120 may obtain (e.g., receive), an acknowledgement communication. The acknowledgement communication may be associated with the indication of the one or more model parameters (e.g., transmitted by the UE 120 as described in connection with reference number 630). For example, the acknowledgment communication may indicate that the network node 110 successfully received the one or more model parameters. The UE 120 may determine that the network node 110 has updated the decoding scheme and/or the power shaping scheme (e.g., as described in connection with reference number 635) based on, in response to, or otherwise associated with receiving the acknowledgement communication.

As shown by reference number 645, the UE 120 may update the power shaping scheme using the one or more model parameters. For example, the UE 120 may determine (e.g., calculate) values for one or more power shaping parameters using the one or more model parameters. In a similar manner as described above in connection with reference number 635, the values of the power shaping parameters may be based on, or otherwise associated with, the one or more model parameters. In other words, for different model parameters, UE 120 may determine or use different power shaping parameters. The UE 120 may determine the power shaping parameters in a similar manner as described elsewhere herein, such as in connection with FIG. 5. In some examples, the UE 120 may store a mapping of model parameter(s) to power shaping parameters. The UE 120 may use the mapping to determine the power shaping parameters for the power shaping scheme. By varying the power shaping parameters for different model parameters, the power shaping scheme may be tailored to the data distribution of the control channel, thereby improving the power efficiency of control channel communications.

The UE 120 may encode, using an encoder, data associated with the control channel. For example, the encoder may include the codebook and the updated power shaping scheme. The updated power shaping scheme may include power shaping parameter(s) for respective codewords, where the power shaping parameter(s) are based on, or otherwise associated with the one or more model parameters (e.g., may use the power shaping parameters determined as described in connection with reference number 645).

The one or more control channel communications may be uplink control channel communications (e.g., PUCCH communications) or another type of control channel communication. The one or more control channel communications may include data (e.g., control information, UCI, feedback information, and/or a feedback codebook) and pilot signals (e.g., one or more DMRSs). The one or more control channel communications may be transmitted (e.g., by the UE 120) and/or received (e.g., by the network node 110) using a codebook, such as the per-codeword power shaping codebook (e.g., the codebook [symbol] ᵢ). For example, the UE 120 may encode the data included in the one or more uplink control channel communications (e.g., the control information, UCI, and/or the feedback information) into one or more bits (e.g., information bits). The UE 120 may map the encoded bits onto one or more codewords selected from the codebook [symbol] ᵢ. The UE 120 may modulate the one or more codewords onto modulated symbols (e.g., codeword symbols).

As shown by reference number 650, UE 120 may transmit the modulated codeword symbols in the one or more uplink control channel communications (e.g., where the modulated codeword symbols are allocated to frequency domain resources (e.g., subcarriers) and time domain resources (e.g., symbols) within a set of one or more resource blocks configured for the uplink control channel). A transmit power of a given codeword may be based on, or otherwise associated with, a power shaping parameter associated with the given codeword. The network node 120 may receive the codeword symbols and may demodulate and/or decode the codeword symbols using the codebook [symbol] ᵢ and the updated power shaping scheme (e.g., determined by the network node 110 as described in connection with reference number 635).

As indicated above, FIG. 6 is provided as an example. Other examples may differ from what is described with respect to FIG. 6.

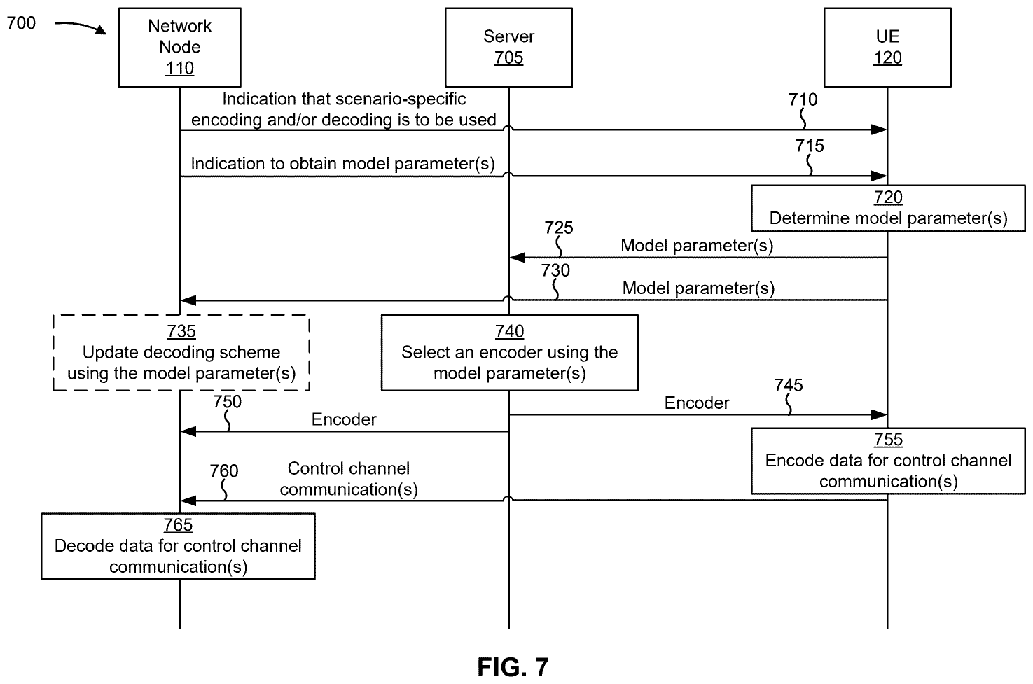

FIG. 7 is a diagram of an example 700 associated with model management for control channel encoding or decoding, in accordance with the present disclosure. As shown in FIG. 7, a network node 110 (e.g., a wireless node, a CU, a DU, and/or an RU) may communicate with a UE 120 (e.g., a wireless node). In some aspects, the network node 110 and the UE 120 may be part of a wireless network (e.g., the wireless network 100). The UE 120 and the network node 110 may have established a wireless connection prior to operations shown in FIG. 7. In some aspects, the example 700 may be part of, or associated with, the example 600. For example, one or more operations described in connection with FIG. 6 may be similarly performed in association with operations described in connection with FIG. 7 (e.g., even if not depicted or described in connection with FIG. 7).

As shown in FIG. 7, the UE 120 and/or the network node 110 may communicate with a server 705. The server 705 may include a communication device and/or a computing device. For example, the server 705 may include an application server, a client server, a web server, a database server, a host server, a proxy server, a virtual server (e.g., executing on computing hardware), or a server in a cloud computing system, among other examples. The server 705 may be configured to store encoders for a control channel, such as the PUCCH. For example, the server 705 may store a mapping between model parameters and encoders for the control channel.

As shown by reference number 710, the UE 120 may receive, and the network node 110 may transmit, an indication that scenario-specific encoding and/or decoding is to be used for the control channel (e.g., the uplink control channel). For example, the network node 110 may output for transmission, and the UE 120 may obtain, an indication that a model, associated with encoding and/or decoding, is to be used in association with a control channel. The model may be a data distribution model configured or trained to output an inference or prediction of a probability of a next bit in a sequence of bits. For example, the model may be configured to predict a next data value in a sequence of control channel data. The model may include an autoregressive model, a transformer, or another type of model. In some aspects, the indication shown by reference number 710 may include an indication of the model to be used by the UE 120. The indication that scenario-specific encoding and/or decoding is to be used may be similar to the indication described in connection with reference number 615.

As shown by reference number 715, the network node 110 may output for transmission, and the UE 120 may obtain, an indication to obtain one or more model parameters. For example, the indication described in connection with reference number 620 may indicate that the UE 120 is to update or modify an encoding scheme used for the control channel. For example, the indication described in connection with reference number 620 may cause or trigger the UE 120 to determine (e.g., calculate) one or more model parameters for the model. The indication to obtain one or more model parameters may be communicated via RRC signaling, MAC signaling, and/or DCI signaling, among other examples. For example, the network node 110 may output for transmission, and the UE 120 may obtain, one or more RRC configuration communications that include the indication to obtain one or more model parameters. As an example, the indication to obtain one or more model parameters may be included in an RRC reconfiguration (e.g., RRCReconfiguration) communication. For example, the RRC reconfiguration communication may include information (e.g., a parameter or IE) indicating that the UE 120 is to update the encoding scheme used for the control channel and/or indicating that the UE 120 is to output or transmit an indication of the one or more model parameters. The indication to obtain one or more model parameters may be similar to the indication described in connection with reference number 620.

As shown by reference number 720, the UE 120 may determine the one or more model parameters. The UE 120 may determine the one or more model parameters using the model. The one or more model parameters may be associated with a data distribution of the control channel over a time interval. For example, the data distribution includes a relative frequency (e.g., frequency of transmission) associated with one or more codewords in the codebook over the time interval. The time interval may be an amount of time between reconfigurations and/or switches associated with the encoding and decoding scheme for the control channel. As another example, the time interval may be an amount of time between reconfigurations and/or switches associated with the model (or multiple models including the model). For example, the time interval may be between a first time (e.g., at which the indication described in connection with reference number 615 is received or obtained by the UE 120) and a second time (e.g., at which the indication described in connection with reference number 620 is received or obtained by the UE 120). For example, the time interval may be a time interval between the model being configured for use and a reconfiguration of the model. As another example, the time interval may be a time interval between a first reconfiguration of the model and a second reconfiguration of the model (e.g., RRC reconfigurations and/or MAC-CE initiated model switches). The UE 120 may determine the one or more model parameters in a similar manner as described in connection with reference number 625.

As shown by reference number 725, the UE 120 may output (e.g., transmit), and the server 705 may obtain (e.g., receive), an indication of the one or more model parameters. For example, the UE 120 may transmit the one or more model parameters via an interface between the UE 120 and the server 705. The UE 120 may output (e.g., transmit) a communication to the server 705. The communication may indicate the one or more model parameters and an identifier of the network node 110. The identifier of the network node 110 may enable the server 705 to identify the network node 110. This may enable the server 705 to transmit a selected encoder to the network node 110, such as described in connection with reference number 750. The identifier of the network node 110 may be a gNB identifier, a group identifier, a public land mobile network (PLMN) identifier, a physical cell identifier (PCI), and/or a tracking area code, among other examples.

Additionally, as shown by reference number 730, the UE 120 may output for transmission (e.g., transmit) and the network node 110 may obtain (e.g., receive), an indication of the one or more model parameters. The UE 120 may transmit the one or more model parameters using RRC signaling, MAC signaling, and/or UCI signaling. For example, the UE 120 may transmit the one or more model parameters via one or more MAC-CEs. In some examples, the UE 120 may transmit the one or more model parameters via the control channel (e.g., via a PUCCH transmission). Alternatively, the UE 120 may transmit the one or more model parameters via a data channel or a shared channel (e.g., via a PUSCH transmission). As described elsewhere herein, the UE 120 may reset the data distribution for the control channel after outputting the one or more model parameters.

In some aspects, as shown by reference number 735, the network node 110 may update a decoding scheme for the control channel using the model parameter(s). For example, the network node 110 may determine and/or obtain, by using the one or more model parameters, a prior distribution (e.g., for a MAP-based decoder). The decoder may be used by the network node 110 to decode data included in control channel communications. The network node 110 may use the prior distribution for decoding data (for example, control channel data, such as PUCCH data).

As shown by reference number 740, the server 705 may select an encoder using the one or more model parameters. For example, the server 705 may select or identify the encoder to be used for the control channel based on, using, or otherwise associated with the one or more model parameters. In some example, the server 705 may use a mapping of model parameters to encoders to select or identify the encoder. As described elsewhere herein, the encoder may include a codebook and a power shaping scheme (e.g., one or more power shaping parameters). For example, both the codebook (e.g., one or more codewords) and the power shaping scheme may vary based on the one or more model parameters.

In some other aspects, the UE 120 and/or the network node 110 may select the encoder using the one or more model parameters in a similar manner as described in connection with reference number 740. In such examples, the example 700 may not include the server 705.

As shown by reference number 745, the server 705 may output (e.g., transmit), and the UE 120 may obtain (e.g., receive), an indication of the encoder. The indication of the encoder may include the codebook and the one or more power shaping parameters (e.g., associated with respective codewords included in the codebook) to be used for the control channel. For example, the UE 120 may download, via the server 705, the encoder. The codebook and the one or more power shaping parameters may be based on, or otherwise associated with, the one or more model parameters. As a result, the codebook and the one or more power shaping parameters may be tailored to the data distribution of the control channel, thereby improving the power efficiency (e.g., transmit power efficiency) for control channel communications or transmissions.

As shown by reference number 750, the server 705 may output (e.g., transmit), and the network node 110 may obtain (e.g., receive), an indication of the encoder. The indication of the encoder may include the codebook and the one or more power shaping parameters (e.g., associated with respective codewords included in the codebook) to be used for the control channel. For example, the network node 110 may download, via the server 705, the encoder. The codebook and the one or more power shaping parameters may be based on, or otherwise associated with, the one or more model parameters. The network node 110 may use the encoder to identify the codebook and/or the power shaping parameter(s) used for control channel communications when decoding the control channel communications.

As shown by reference number 755, the UE 120 may encode, using the encoder, data associated with the control channel. For example, the encoder may include the codebook and the power shaping scheme. The power shaping scheme may include power shaping parameter(s) for respective codewords, where the power shaping parameter(s) are based on, or otherwise associated with the one or more model parameters (e.g., the UE 120 may use the encoder indicated by the server 705 as described in connection with reference number 745).

The one or more control channel communications may be uplink control channel communications (e.g., PUCCH communications) or another type of control channel communication. The one or more control channel communications may include data (e.g., control information, UCI, feedback information, and/or a feedback codebook) and pilot signals (e.g., one or more DMRSs). The one or more control channel communications may be transmitted (e.g., by the UE 120) and/or received (e.g., by the network node 110) using a codebook, such as the per-codeword power shaping codebook (e.g., the codebook [symbol] ᵢ). For example, the UE 120 may encode the data included in the one or more uplink control channel communications (e.g., the control information, UCI, and/or the feedback information) into one or more bits (e.g., information bits). The UE 120 may map the encoded bits onto one or more codewords selected from the codebook [symbol] ᵢ. The UE 120 may modulate the one or more codewords onto modulated symbols (e.g., codeword symbols).

As shown by reference number 760, UE 120 may transmit the modulated codeword symbols in the one or more uplink control channel communications (e.g., where the modulated codeword symbols are allocated to frequency domain resources (e.g., subcarriers) and time domain resources (e.g., symbols) within a set of one or more resource blocks configured for the uplink control channel). A transmit power of a given codeword may be based on, or otherwise associated with, a power shaping parameter associated with the given codeword. The network node 120 may receive the codeword symbols and, as shown by reference number 765, may demodulate and/or decode the codeword symbols using the codebook [symbol] ᵢ and the encoder (e.g., indicated to the network node 110 by the server 705 as described in connection with reference number 750).

As indicated above, FIG. 7 is provided as an example. Other examples may differ from what is described with respect to FIG. 7.

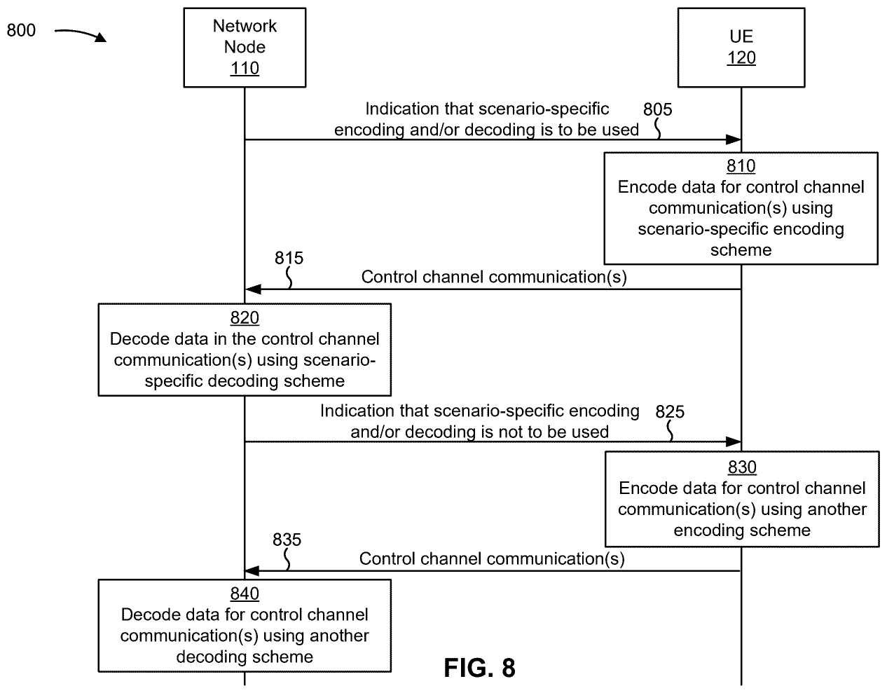

FIG. 8 is a diagram of an example 800 associated with model management for control channel encoding or decoding, in accordance with the present disclosure. As shown in FIG. 8, a network node 110 (e.g., a wireless node, a CU, a DU, and/or an RU) may communicate with a UE 120 (e.g., a wireless node). In some aspects, the network node 110 and the UE 120 may be part of a wireless network (e.g., the wireless network 100). The UE 120 and the network node 110 may have established a wireless connection prior to operations shown in FIG. 8. In some aspects, the example 800 may be part of, or associated with, the example 600 and/or the example 700. For example, one or more operations described in connection with FIG. 6 and/or FIG. 7 may be similarly performed in association with operations described in connection with FIG. 8 (e.g., even if not depicted or described in connection with FIG. 8).

As shown by reference number 805, the UE 120 may receive, and the network node 110 may transmit, an indication that scenario-specific encoding and/or decoding is to be used for the control channel (e.g., the uplink control channel). For example, the network node 110 may output for transmission, and the UE 120 may obtain, an indication that a model, associated with encoding and/or decoding, is to be used in association with a control channel. The model may be a data distribution model configured or trained to output an inference or prediction of a probability of a next bit in a sequence of bits. For example, the model may be configured to predict a next data value in a sequence of control channel data. The model may include an autoregressive model, a transformer, or another type of model. In some aspects, the indication shown by reference number 710 may include an indication of the model to be used by the UE 120. The indication that scenario-specific encoding and/or decoding is to be used may be similar to the indication described in connection with reference number 615, reference number 620, reference number 710, and/or reference number 715.

For example, the network node 110 may enable the use of scenario-specific encoding or decoding via higher layer signaling (e.g., RRC signaling and/or MAC singling). The enabling of the scenario-specific encoding or decoding may indicate an encoder and/or a decoder is to be used for the control channel, where the encoder and/or the decoder are associated with, or based on, the data distribution of the control channel over a given time interval, as described in more detail elsewhere herein, such as in connection with FIGS. 6 and 7.

As shown by reference number 810, the UE 120 may encode data for one or more control channel communications using a scenario specific encoding scheme. For example, the UE 120 may encode the data using a codebook and/or one or more power shaping parameters that are based on, or otherwise associated with, the one or more model parameters, as described in more detail elsewhere herein. As shown by reference number 815, the UE 120 may output (e.g., transmit), and the network node 110 may obtain (e.g., receive), the one or more control channel communications. As shown by reference number 820, the network node 110 may decode the data included in the one or more control channel communications using a scenario-specific decoding scheme. The scenario-specific decoding scheme may include the network node 110 decoding the data using a decoder that is configured using the one or more model parameters (e.g., where a prior of the decoder is based on, or otherwise associated with the one or more model parameters). Additionally, or alternatively, the scenario-specific decoding scheme may include the network node 110 decoding the data using an encoder (e.g., a codebook and/or one or more power shaping parameters) that is based on, or otherwise associated with the one or more model parameters.

In some aspects, as shown by reference number 825, the network node 110 may output (e.g., transmit), and the UE 120 may obtain (e.g., receive), an indication that scenario-specific encoding and/or decoding is not to be used (e.g., is no longer to be used) for the control channel. For example, the network node 110 may output (e.g., transmit), and the UE 120 may obtain (e.g., receive), an indication that the model is not to be used in association with the control channel. The network node 110 may transmit the indication that scenario-specific encoding and/or decoding is not to be used via higher layer signaling, such as RRC signaling and/or MAC signaling (e.g., one or more MAC-CEs), among other examples. For example, the indication that scenario-specific encoding and/or decoding is not to be used may indicate that data distribution agnostic encoding and/or decoding is to be used for the control channel.

As shown by reference number 830, the UE 120 may encode data for one or more control channel communications using another encoding scheme. The other encoding scheme may be a channel or data distribution agnostic encoding scheme. For example, the other encoding scheme may include an encoding scheme defined, or otherwise fixed, by a wireless communication standard, such as the 3GPP. For example, the other encoding scheme may include an NR(11,32) encoding algorithm as defined, or otherwise fixed, by a wireless communication standard, such as the 3GPP.

As shown by reference number 835, the UE 120 may output (e.g., transmit), after obtaining the indication that the model is not to be used in association with the control channel, data that was encoded by using a different encoder (e.g., using the other encoding scheme). For example, the UE 120 may encode the data independent of the model. As shown by reference number 840, the network node 110 may decode the data using a different decoding scheme (e.g., a channel or data distribution agnostic decoding scheme). For example, the codebook used for the different decoding scheme and/or the different decoding scheme may use a single power control parameter for all codewords included in the codebook. In some aspects, the different decoding scheme may include decoding using a maximum likelihood decoding operation.

As indicated above, FIG. 8 is provided as an example. Other examples may differ from what is described with respect to FIG. 8.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with model management for control channel encoding or decoding.

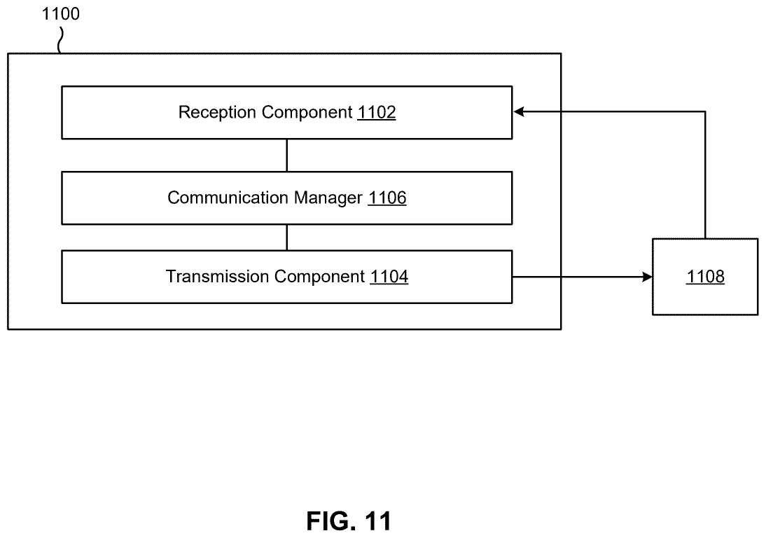

As shown in FIG. 9, in some aspects, process 900 may include obtaining an indication that a model, associated with at least one of encoding or decoding, is to be used in association with a control channel (block 910). For example, the UE (e.g., using reception component 1102 and/or communication manager 1106, depicted in FIG. 11) may obtain an indication that a model, associated with at least one of encoding or decoding, is to be used in association with a control channel, as described above.

As further shown in FIG. 9, in some aspects, process 900 may include outputting, after obtaining the indication, one or more model parameters associated with a data distribution of the control channel (block 920). For example, the UE (e.g., using transmission component 1104 and/or communication manager 1106, depicted in FIG. 11) may output, after obtaining the indication, one or more model parameters associated with a data distribution of the control channel, as described above. The one or more model parameters may be associated with (e.g., obtained via) the model.

As further shown in FIG. 9, in some aspects, process 900 may include encoding data by using the one or more model parameters (block 930). For example, the UE (e.g., using communication manager 1106, depicted in FIG. 11) may encode data by using the one or more model parameters, as described above.

As further shown in FIG. 9, in some aspects, process 900 may include outputting the data for transmission via the control channel (block 940). For example, the UE (e.g., using transmission component 1104 and/or communication manager 1106, depicted in FIG. 11) may output the data for transmission via the control channel, as described above.

Process 900 may include additional aspects, such as any single aspect or any combination of aspects described below and/or in connection with one or more other processes described elsewhere herein.

In a first aspect, the data distribution includes a relative frequency associated with one or more codewords over a time interval.

In a second aspect, alone or in combination with the first aspect, the model includes an autoregressive model or a transformer, and the autoregressive model and the transformer are configured to predict a next data value in a sequence of control channel data.

In a third aspect, alone or in combination with one or more of the first and second aspects, an order of the autoregressive model is one or two.

In a fourth aspect, alone or in combination with one or more of the first through third aspects, process 900 includes training the model using the data distribution, and obtaining, via the model and after training the model, the one or more model parameters.

In a fifth aspect, alone or in combination with one or more of the first through fourth aspects, the encoding further uses a codebook, wherein the codebook is a per-codeword power shaping codebook that includes power shaping parameters for respective codewords included in the codebook, and wherein the power shaping parameters are associated with the one or more model parameters.

In a sixth aspect, alone or in combination with one or more of the first through fifth aspects, obtaining the indication that the model is to be used includes at least one of obtaining a first communication indicating that the model is enabled for use, or obtaining a second communication indicating that the model is to be reconfigured for the control channel.

In a seventh aspect, alone or in combination with one or more of the first through sixth aspects, outputting the one or more model parameters includes obtaining, via the model and by using the data distribution, the one or more model parameters after obtaining the second communication.

In an eighth aspect, alone or in combination with one or more of the first through seventh aspects, the data distribution is associated with a time period between obtaining the second communication and obtaining the first communication, or obtaining a previous communication indicating that the model is to be reconfigured.

In a ninth aspect, alone or in combination with one or more of the first through eighth aspects, process 900 includes resetting the data distribution after outputting the one or more model parameters.

In a tenth aspect, alone or in combination with one or more of the first through ninth aspects, outputting the one or more model parameters includes outputting, for transmission to a network node, the one or more model parameters.

In an eleventh aspect, alone or in combination with one or more of the first through tenth aspects, process 900 includes obtaining an indication that the network node successfully obtained the one or more model parameters, and outputting, for transmission to the network node, the data after obtaining the indication that the network node successfully received the one or more model parameters.

In a twelfth aspect, alone or in combination with one or more of the first through eleventh aspects, outputting the one or more model parameters includes outputting, for transmission to a server, the one or more model parameters.

In a thirteenth aspect, alone or in combination with one or more of the first through twelfth aspects, process 900 includes obtaining, after outputting the one or more model parameters for transmission to the server, a codebook and one or more power shaping parameters, wherein the encoding further uses the codebook and the one or more power shaping parameters.

In a fourteenth aspect, alone or in combination with one or more of the first through thirteenth aspects, process 900 includes obtaining an indication that the model is not to be used in association with the control channel, and outputting for transmission, after obtaining the indication that the model is not to be used in association with the control channel, other data that was encoded independent of the model.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node, in accordance with the present disclosure. Example process 1000 is an example where the apparatus or the network node (e.g., network node 110) performs operations associated with model management for control channel encoding or decoding.

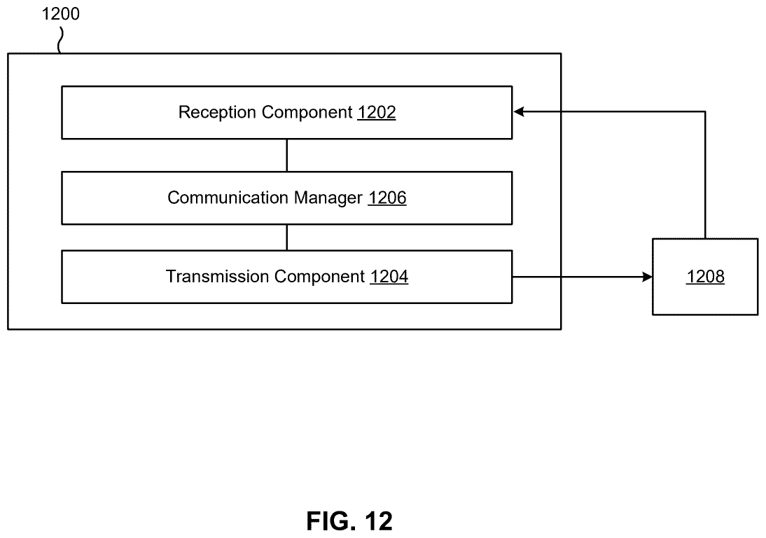

As shown in FIG. 10, in some aspects, process 1000 may include outputting an indication that a model, associated with at least one of encoding or decoding, is to be used in association with a control channel (block 1010). For example, the network node (e.g., using transmission component 1204 and/or communication manager 1206, depicted in FIG. 12) may output an indication that a model, associated with at least one of encoding or decoding, is to be used in association with a control channel, as described above.

As further shown in FIG. 10, in some aspects, process 1000 may include obtaining, after outputting the indication that the model is to be used, one or more model parameters associated with a data distribution of the control channel (block 1020). For example, the network node (e.g., using reception component 1202 and/or communication manager 1206, depicted in FIG. 12) may obtain, after outputting the indication that the model is to be used, one or more model parameters associated with a data distribution of the control channel, as described above.

As further shown in FIG. 10, in some aspects, process 1000 may include obtaining data associated with the control channel (block 1030). For example, the network node (e.g., using reception component 1202 and/or communication manager 1206, depicted in FIG. 12) may obtain data associated with the control channel, as described above.

As further shown in FIG. 10, in some aspects, process 1000 may include decoding the data by using the one or more model parameters (block 1040). For example, the network node (e.g., using communication manager 1206, depicted in FIG. 12) may decode the data by using the one or more model parameters, as described above.

Process 1000 may include additional aspects, such as any single aspect or any combination of aspects described below and/or in connection with one or more other processes described elsewhere herein.

In a first aspect, the data distribution includes a relative frequency of one or more codewords over a time interval.

In a second aspect, alone or in combination with the first aspect, the model includes an autoregressive model or a transformer, where the autoregressive model and the transformer are configured to predict a next data value in a sequence of control channel data.

In a third aspect, alone or in combination with one or more of the first and second aspects, an order of the autoregressive model is one or two.

In a fourth aspect, alone or in combination with one or more of the first through third aspects, process 1000 includes obtaining, by using the one or more model parameters, a prior distribution, where the decoding further uses the prior distribution.

In a fifth aspect, alone or in combination with one or more of the first through fourth aspects, the decoding further uses a codebook, wherein the codebook is a per-codeword power shaping codebook that includes power shaping parameters for respective codewords included in the codebook, and wherein the power shaping parameters are associated with the one or more model parameters.

In a sixth aspect, alone or in combination with one or more of the first through fifth aspects, outputting the indication that the model is to be used includes outputting for transmission a first communication indicating that the model is enabled for use, and outputting for transmission a second communication indicating that the model is to be reconfigured for the control channel.

In a seventh aspect, alone or in combination with one or more of the first through sixth aspects, the data distribution is associated with a time period between outputting the second communication and outputting the first communication, or outputting a previous communication indicating that the model is to be reconfigured.

In an eighth aspect, alone or in combination with one or more of the first through seventh aspects, the one or more model parameters are obtained via a UE.

In a ninth aspect, alone or in combination with one or more of the first through eighth aspects, process 1000 includes outputting, for transmission to the UE, an indication that the one or more model parameters were successfully obtained.

In a tenth aspect, alone or in combination with one or more of the first through ninth aspects, obtaining the one or more model parameters includes obtaining a codebook and one or more power shaping parameters via a server, wherein the decoding further uses the codebook and the one or more power shaping parameters.

In an eleventh aspect, alone or in combination with one or more of the first through tenth aspects, process 1000 includes outputting for transmission an indication that the model is not to be used in association with the control channel, and obtaining, after outputting for transmission the indication that the model is not to be used in association with the control channel, other data that is decoded independent of the model.

In a twelfth aspect, alone or in combination with one or more of the first through eleventh aspects, process 1000 includes transmitting the indication that the model is to be used in association with the control channel, receiving the one or more model parameters, and receiving, via the control channel, the data.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 6-8. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

In some cases, rather than actually transmitting, for example, signals and/or data, a device may have an interface to output signals and/or data for transmission (a means for outputting). For example, a processor may output signals and/or data, via a bus interface, to an RF front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, and/or modems, among other examples, such as depicted in the examples in FIG. 2.

The reception component 1102 may obtain an indication that a model, associated with at least one of encoding or decoding, is to be used in association with a control channel. The transmission component 1104 may output, after obtaining the indication, one or more model parameters associated with a data distribution of the control channel. The communication manager 1106 may encode data by using the one or more model parameters. The transmission component 1104 may output the data for transmission via the control channel.

The communication manager 1106 may train the model using the data distribution. The reception component 1102 may obtain, via the model and after training the model, the one or more model parameters. The communication manager 1106 may reset the data distribution after outputting the one or more model parameters.

The reception component 1102 may obtain an indication that the network node successfully obtained the one or more model parameters. The transmission component 1104 may output, for transmission to the network node, the data after obtaining the indication that the network node successfully received the one or more model parameters. The reception component 1102 may obtain, after outputting the one or more model parameters for transmission to the server, a codebook and one or more power shaping parameters, where the encoding further uses the codebook and the one or more power shaping parameters.

The reception component 1102 may obtain an indication that the model is not to be used in association with the control channel. The transmission component 1104 may output for transmission, after obtaining the indication that the model is not to be used in association with the control channel, other data that was encoded independent of the model.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 6-8. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1204 may be co-located with the reception component 1202 in one or more transceivers.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

In some cases, rather than actually transmitting, for example, signals and/or data, a device may have an interface to output signals and/or data for transmission (a means for outputting). For example, a processor may output signals and/or data, via a bus interface, to an RF front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, and/or modems, among other examples, such as depicted in the examples in FIG. 2.

The transmission component 1204 may output an indication that a model, associated with at least one of encoding or decoding, is to be used in association with a control channel. The reception component 1202 may obtain, after outputting the indication that the model is to be used, one or more model parameters associated with a data distribution of the control channel. The reception component 1202 may obtain data associated with the control channel. The communication manager 1206 may decode the data by using the one or more model parameters.

The reception component 1202 may obtain, by using the one or more model parameters, a prior distribution, where the communication manager 1206 further uses the prior distribution for the decoding. The transmission component 1204 may output, for transmission to the UE, an indication that the one or more model parameters were successfully obtained. The transmission component 1204 may output for transmission an indication that the model is not to be used in association with the control channel.

The reception component 1202 may obtain, after outputting for transmission the indication that the model is not to be used in association with the control channel, other data that is decoded independent of the model. The transmission component 1204 may transmit the indication that the model is to be used in association with the control channel.

The reception component 1202 may receive the one or more model parameters. The reception component 1202 may receive, via the control channel, the data.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed at a wireless node, comprising: obtaining an indication that a model, associated with at least one of encoding or decoding, is to be used in association with a control channel; outputting, after obtaining the indication, one or more model parameters associated with a data distribution of the control channel; encoding data by using the one or more model parameters; and outputting the data for transmission via the control channel.

Aspect 2: The method of Aspect 1, wherein the data distribution includes a relative frequency associated with one or more codewords over a time interval.

Aspect 3: The method of any of Aspects 1-2, wherein the model includes an autoregressive model or a transformer, wherein the autoregressive model and the transformer are configured to predict a next data value in a sequence of control channel data.

Aspect 4: The method of Aspect 3, wherein an order of the autoregressive model is one or two.

Aspect 5: The method of any of Aspects 1-4, further comprising: training the model using the data distribution; and obtaining, via the model and after training the model, the one or more model parameters.

Aspect 6: The method of any of Aspects 1-5, wherein the encoding further uses a codebook, wherein the codebook is a per-codeword power shaping codebook that includes power shaping parameters for respective codewords included in the codebook, and wherein the power shaping parameters are associated with the one or more model parameters.

Aspect 7: The method of any of Aspects 1-6, wherein obtaining the indication that the model is to be used comprises at least one of: obtaining a first communication indicating that the model is enabled for use; or obtaining a second communication indicating that the model is to be reconfigured for the control channel.

Aspect 8: The method of Aspect 7, wherein outputting the one or more model parameters comprises: obtaining, via the model and by using the data distribution, the one or more model parameters after obtaining the second communication.

Aspect 9: The method of any of Aspects 7-8, wherein the data distribution is associated with a time period between obtaining the second communication and: obtaining the first communication, or obtaining a previous communication indicating that the model is to be reconfigured.

Aspect 10: The method of any of Aspects 1-9, further comprising: resetting the data distribution after outputting the one or more model parameters.

Aspect 11: The method of any of Aspects 1-10, wherein outputting the one or more model parameters comprises: outputting, for transmission to a network node, the one or more model parameters.

Aspect 12: The method of Aspect 11, further comprising: obtaining an indication that the network node successfully obtained the one or more model parameters; and outputting, for transmission to the network node, the data after obtaining the indication that the network node successfully received the one or more model parameters.

Aspect 13: The method of any of Aspects 1-12, wherein outputting the one or more model parameters comprises: outputting, for transmission to a server, the one or more model parameters.

Aspect 14: The method of Aspect 13, further comprising: obtaining, after outputting the one or more model parameters for transmission to the server, a codebook and one or more power shaping parameters, wherein the encoding further uses the codebook and the one or more power shaping parameters.

Aspect 15: The method of any of Aspects 1-14, further comprising: obtaining an indication that the model is not to be used in association with the control channel; and outputting for transmission, after obtaining the indication that the model is not to be used in association with the control channel, other data that was encoded independent of the model.

Aspect 16: A method of wireless communication performed at a wireless node, comprising: outputting an indication that a model, associated with at least one of encoding or decoding, is to be used in association with a control channel; obtaining, after outputting the indication that the model is to be used, one or more model parameters associated with a data distribution of the control channel; obtaining data associated with the control channel; and decoding the data by using the one or more model parameters.

Aspect 17: The method of Aspect 16, wherein the data distribution includes a relative frequency of one or more codewords over a time interval.

Aspect 18: The method of any of Aspects 16-17, wherein the model includes an autoregressive model or a transformer, wherein the autoregressive model and the transformer are configured to predict a next data value in a sequence of control channel data.

Aspect 19: The method of Aspect 18, wherein an order of the autoregressive model is one or two.

Aspect 20: The method of any of Aspects 16-19, further comprising: obtaining, by using the one or more model parameters, a prior distribution, wherein the decoding further uses the prior distribution.

Aspect 21: The method of any of Aspects 16-20, wherein the decoding further uses a codebook, wherein the codebook is a per-codeword power shaping codebook that includes power shaping parameters for respective codewords included in the codebook, and wherein the power shaping parameters are associated with the one or more model parameters.

Aspect 22: The method of any of Aspects 16-21, wherein outputting the indication that the model is to be used comprises: outputting for transmission a first communication indicating that the model is enabled for use; and outputting for transmission a second communication indicating that the model is to be reconfigured for the control channel.

Aspect 23: The method of Aspect 22, wherein the data distribution is associated with a time period between outputting the second communication and: outputting the first communication, or outputting a previous communication indicating that the model is to be reconfigured.

Aspect 24: The method of any of Aspects 16-23, wherein the one or more model parameters are obtained via a user equipment (UE).

Aspect 25: The method of Aspect 24, further comprising: outputting, for transmission to the UE, an indication that the one or more model parameters were successfully obtained.

Aspect 26: The method of any of Aspects 16-25, wherein obtaining the one or more model parameters comprises: obtaining a codebook and one or more power shaping parameters via a server, wherein the decoding further uses the codebook and the one or more power shaping parameters.

Aspect 27: The method of any of Aspects 16-26, further comprising: outputting for transmission an indication that the model is not to be used in association with the control channel; and obtaining, after outputting for transmission the indication that the model is not to be used in association with the control channel, other data that is decoded independent of the model.

Aspect 28: The method of any of Aspects 16-27, further comprising: transmitting the indication that the model is to be used in association with the control channel; receiving the one or more model parameters; and receiving, via the control channel, the data.

Aspect 29: An apparatus for wireless communication comprising one or more memories comprising instructions and one or more processors configured to execute the instructions and cause the apparatus to perform the method of one or more of Aspects 1-15.

Aspect 30: A wireless node (e.g., a UE), comprising at least one transceiver, one or more memories comprising instructions, and one or more processors configured to execute the instructions and cause the wireless node to perform the method of one or more of Aspects 1-15, wherein the at least one transceiver is configured to receive indication that the model is to be used in association with the control channel; transmit the one or more model parameters associated with the data distribution of the control channel; and transmit the data via the control channel.

Aspect 31: An apparatus for wireless communication, the apparatus comprising at least one means for performing the method of one or more of Aspects 1-15.

Aspect 32: A non-transitory computer-readable medium storing a set of instructions for wireless communication, the set of instructions comprising one or more instructions that, when executed by an apparatus, cause the apparatus to perform the method of one or more of Aspects 1-15.

Aspect 33: An apparatus for wireless communication comprising one or more memories comprising instructions and one or more processors configured to execute the instructions and cause the apparatus to perform the method of one or more of Aspects 16-28.

Aspect 34: A wireless node (e.g., a network node), comprising at least one transceiver, one or more memories comprising instructions, and one or more processors configured to execute the instructions and cause the wireless node to perform the method of one or more of Aspects 16-28, wherein the at least one transceiver is configured to transmit the indication that the model is to be used in association with the control channel; receive the one or more model parameters associated with the data distribution of the control channel; and receive the data via the control channel.

Aspect 35: An apparatus for wireless communication, the apparatus comprising at least one means for performing the method of one or more of Aspects 16-28.

Aspect 36: A non-transitory computer-readable medium storing a set of instructions for wireless communication, the set of instructions comprising one or more instructions that, when executed by an apparatus, cause the apparatus to perform the method of one or more of Aspects 16-28.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

Further, while the present disclosure may describe certain types of communications between different types of wireless nodes (e.g., between a network node and a UE), the same or similar types of communications may occur between same types of wireless nodes (e.g., between network nodes or between UEs, in a peer-to-peer scenario). Further, communications may occur in reverse order than described.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication, comprising:
one or more memories comprising instructions; and
one or more processors configured to execute the instructions and cause the apparatus to:
obtain an indication that a model, associated with at least one of encoding or decoding, is to be used in association with a control channel;
output, after obtaining the indication, one or more model parameters associated with a data distribution of the control channel;
encode data by using the one or more model parameters; and
output the data for transmission via the control channel.

2. The apparatus of claim 1, wherein the data distribution includes a relative frequency associated with one or more codewords over a time interval.

3. The apparatus of claim 1, wherein the model includes an autoregressive model or a transformer, wherein the autoregressive model and the transformer are configured to predict a next data value in a sequence of control channel data.

4. The apparatus of claim 1, wherein the one or more processors are further configured to cause the apparatus to:
train the model using the data distribution; and
obtain, via the model and after training the model, the one or more model parameters.

5. The apparatus of claim 1, wherein the encoding further uses a codebook, wherein the codebook is a per-codeword power shaping codebook that includes power shaping parameters for respective codewords included in the codebook, and wherein the power shaping parameters are associated with the one or more model parameters.

6. The apparatus of claim 1, wherein the one or more processors, to cause the apparatus to obtain the indication that the model is to be used, are configured to cause the apparatus to:
obtain a first communication indicating that the model is enabled for use; or
obtain a second communication indicating that the model is to be reconfigured for the control channel.

7. The apparatus of claim 6, wherein the one or more processors, to cause the apparatus to output the one or more model parameters, are configured to cause the apparatus to:
obtain, via the model and by using the data distribution, the one or more model parameters after obtaining the second communication.

8. The apparatus of claim 6, wherein the data distribution is associated with a time period between obtaining the second communication and:
obtaining the first communication, or
obtaining a previous communication indicating that the model is to be reconfigured.

9. The apparatus of claim 1, wherein the one or more processors are further configured to cause the apparatus to:
reset the data distribution after outputting the one or more model parameters.

10. The apparatus of claim 1, wherein the one or more processors, to cause the apparatus to output the one or more model parameters, are configured to cause the apparatus to:
output, for transmission to a network node, the one or more model parameters.

11. The apparatus of claim 10, wherein the one or more processors are further configured to cause the apparatus to:
obtain an indication that the network node successfully obtained the one or more model parameters; and
output, for transmission to the network node, the data after obtaining the indication that the network node successfully received the one or more model parameters.

12. The apparatus of claim 1, wherein the one or more processors, to cause the apparatus to output the one or more model parameters, are configured to cause the apparatus to:
output, for transmission to a server, the one or more model parameters.

13. The apparatus of claim 12, wherein the one or more processors are further configured to cause the apparatus to:
obtain, after outputting the one or more model parameters for transmission to the server, a codebook and one or more power shaping parameters, wherein the encoding further uses the codebook and the one or more power shaping parameters.

14. The apparatus of claim 1, wherein the one or more processors are further configured to cause the apparatus to:
obtain an indication that the model is not to be used in association with the control channel; and
output for transmission, after obtaining the indication that the model is not to be used in association with the control channel, other data that was encoded independent of the model.

15. The apparatus of claim 1, further comprising at least one transceiver configured to:
receive the indication;
transmit the one or more model parameters; and
transmit the data, wherein the apparatus is configured as a user equipment.

16. An apparatus for wireless communication, comprising:
one or more memories comprising instructions; and
one or more processors configured to execute the instructions and cause the apparatus to:
output an indication that a model, associated with at least one of encoding or decoding, is to be used in association with a control channel;
obtain, after outputting the indication that the model is to be used, one or more model parameters associated with a data distribution of the control channel;
obtain data associated with the control channel; and
decode the data by using the one or more model parameters.

17. The apparatus of claim 16, wherein the one or more processors are further configured to cause the apparatus to:
obtain, by using the one or more model parameters, a prior distribution, wherein the decoding further uses the prior distribution.

18. The apparatus of claim 16, wherein the decoding further uses a codebook, wherein the codebook is a per-codeword power shaping codebook that includes power shaping parameters for respective codewords included in the codebook, and wherein the power shaping parameters are associated with the one or more model parameters.

19. The apparatus of claim 16, wherein the one or more processors, to cause the apparatus to output the indication that the model is to be used, are configured to cause the apparatus to:
output for transmission a first communication indicating that the model is enabled for use; and
output for transmission a second communication indicating that the model is to be reconfigured for the control channel.

20. The apparatus of claim 19, wherein the data distribution is associated with a time period between outputting the second communication and:
outputting the first communication, or
outputting a previous communication indicating that the model is to be reconfigured.

21. The apparatus of claim 16, wherein the one or more model parameters are obtained via a user equipment (UE).

22. The apparatus of claim 21, wherein the one or more processors are further configured to cause the apparatus to:
output, for transmission to the UE, an indication that the one or more model parameters were successfully obtained.

23. The apparatus of claim 16, wherein the one or more processors, to cause the apparatus to obtain the one or more model parameters, are configured to cause the apparatus to:
obtain a codebook and one or more power shaping parameters via a server, wherein the decoding further uses the codebook and the one or more power shaping parameters.

24. The apparatus of claim 16, further comprising at least one transceiver configured to:
transmit the indication;
receive the one or more model; and
receive the data, wherein the apparatus is configured as a network node.

25. A method of wireless communication performed at wireless node, comprising:
obtaining an indication that a model, associated with at least one of encoding or decoding, is to be used in association with a control channel;
outputting, after obtaining the indication, one or more model parameters associated with a data distribution of the control channel;
encoding data by using the one or more model parameters; and
outputting the data for transmission via the control channel.
